(19) United States
(12) Patent Application Publication
(10) Pub. No.: US 2013/0332513 A1
(43) Pub. Date: Dec. 12, 2013

(54) COMMUNICATION SYSTEM, SERVER APPARATUS, AND CLIENT APPARATUS

(71) Applicant: Tadashi Honda, Kanagawa (JP)

(72) Inventor: Tadashi HONDA, Kanagawa (JP)

(73) Assignee: RICOH COMPANY, LTD., TOKYO (JP)

(21) Appl. No.: 13/892,434

(22) Filed: May 13, 2013

(30) Foreign Application Priority Data
Jun. 12, 2012 (JP) 2012-133233

(51) Int. Cl. H04L 29/06

(52) U.S. Cl. CPC H04L 67/42
USPC 709/203

(57) ABSTRACT

A communication system including a client apparatus and a server apparatus is disclosed. The client apparatus includes a connection request unit that transmits a connection request that contains attribute information including client apparatus identification information identifying the client apparatus. The attribute information is obtained from at least one of a desired content and a gesture made using the client apparatus. The server apparatus includes a request accepting unit that receives the connection request from the client apparatus, a registration unit that registers the attribute information included in the received connection request, and an association unit that determines an association of the registered attribute information and determines, based on the association of the registered attribute information, whether there is a connectable client apparatus to which the client apparatus identified by the client apparatus identification information included in the connection request can be connected.

### BACKGROUND OF THE INVENTION

1. Field of the Invention

The disclosures herein relate to a communication system including a server apparatus and a client apparatus.

2. Description of the Related Art

Various types of conference support systems are currently available on the market (see, e.g., Japanese Laid-Open Patent Publication No. 2006-146415). As illustrated in FIG. 1, these systems are configured to provide a virtual space on a server apparatus (cloud server or local server) to be used as a “box for storing information relating to a conference,” for example. In this box, bibliographic information items (e.g., conference name, conference date & time, conference location, attendee list, and devices to be used) may be registered beforehand. Further, contents to be used at the conference (e.g., conference materials, drawings, moving images, and audio) may be registered. After such preparations, a conference start notification is sent to attendees. In this way, the attendees may access this box during the conference using a browser, for example, to share contents and other information.

In using such conference support systems, users would generally wish to minimize the preparation time required before holding a conference and start the actual conference right away. In the conference, users would want to share information related to a particular topic, hold discussions on the topic, and reach a conclusion, for example. However, in practice, users have to make preparations for the conference as illustrated in FIG. 1. If preparatory procedures for a conference are complicated, time may be wasted on preparations for the conference and time spent on the actual conference may be reduced as a result. Such a system would be unattractive to users and would not be widely used.

### SUMMARY OF THE INVENTION

It is a general object of at least one embodiment of the present invention to provide a communication system that substantially obviates one or more problems caused by the limitations and disadvantages of the related art.

According to one embodiment of the present invention, a communication system includes a client apparatus and a server apparatus. The client apparatus includes a connection request unit that transmits a connection request that contains attribute information including client apparatus identification information identifying the client apparatus. The attribute information is obtained from at least one of a desired content and a gesture made using the client apparatus. The server apparatus includes a request accepting unit that receives the connection request from the client apparatus, a registration unit that registers the attribute information included in the received connection request, and an association unit that determines an association of the registered attribute information and determines, based on the association of the registered attribute information, whether there is a connectable client apparatus to which the client apparatus identified by the client apparatus identification information included in the connection request can be connected.

According to an aspect of the present invention, a communication system may be provided that is capable of establishing connection between client apparatuses via a server apparatus through simple operations.

### BRIEF DESCRIPTION OF THE DRAWINGS

Other objects and further features of embodiments will be apparent from the following detailed descriptions when read in conjunction with the accompanying drawings, in which:

FIG. 1 illustrates typical preparation procedures of a conference support system;

FIG. 2 illustrates an overall configuration of a communication system according to a first embodiment of the present invention;

FIG. 3 illustrates functional features of a server apparatus and a client apparatus for implementing a content registration process according to the first embodiment;

FIG. 4 illustrates exemplary operations of the communication system according to the first embodiment;

FIG. 5 illustrates functional features of the server apparatus and the client apparatus for implementing a content association process according to a second embodiment of the present invention;

FIG. 6 illustrates an exemplary data configuration of content stored in a content database;

FIG. 7 illustrates an overall configuration of a communication system according to the second embodiment;

FIG. 8 is a flowchart illustrating exemplary processes implemented by the communication system according to the second embodiment;

FIG. 9 illustrates functional features of the server apparatus and a PC for implementing a document registration process according to the second embodiment;

FIG. 10 illustrates exemplary operations of the communication system according to the second embodiment;

FIG. 11 illustrates an exemplary data configuration of a document stored as content in the content database according to the second embodiment;

FIG. 12 illustrates functional features of the server apparatus, the client apparatus, and a printer for implementing a document printing process according to the second embodiment;

FIG. 13 illustrates functional features of the server apparatus and a teleconference terminal for implementing a device connection process according to the second embodiment;

FIG. 14 is a flowchart illustrating exemplary process operations of the device connection process according to the second embodiment;

FIG. 15 illustrates an overall configuration of a communication system according to a third embodiment of the present invention;

FIG. 16 is a flowchart illustrating a process implemented by the communication system according to the third embodiment;

FIG. 17 illustrates exemplary operations of the communication system according to the third embodiment;

FIG. 18 illustrates an exemplary data configuration of a location stored as content in the content database according to the third embodiment;

FIG. 19 illustrates functional features of the server apparatus and a mobile terminal for implementing a device connection process according to the third embodiment;

FIG. 20 is a flowchart illustrating exemplary process operations of the device connection process according to the third embodiment;

FIG. 21 is a flowchart illustrating processes implemented by a communication system according to a fourth embodiment of the present invention;

FIG. 22 illustrates functional features the server apparatus and the PC for implementing a location registration process according to the fourth embodiment;

FIG. 23 illustrates an exemplary data configuration of a location stored as content in the content database according to the fourth embodiment;

FIG. 24 illustrates exemplary operations of the communication system according to the fourth embodiment;

FIG. 25 illustrates an exemplary arrangement of mobile terminals as devices to be connected in a modified embodiment of the present invention;

FIG. 26 illustrates an exemplary device information list and a connectable list used in the modified embodiment;

FIG. 27 illustrates an exemplary configuration of a conference database provided as a separate database from the content database; and

FIG. 28 illustrates an exemplary manner of using information relating to the number of device connections established.

### DESCRIPTION OF THE PREFERRED EMBODIMENTS

In the following, embodiments of the present invention are described with reference to the accompanying drawings. It is noted that identical or corresponding features illustrated in more than one of the drawings may be identified by the same reference numerals and their descriptions may be omitted.

<Introduction>

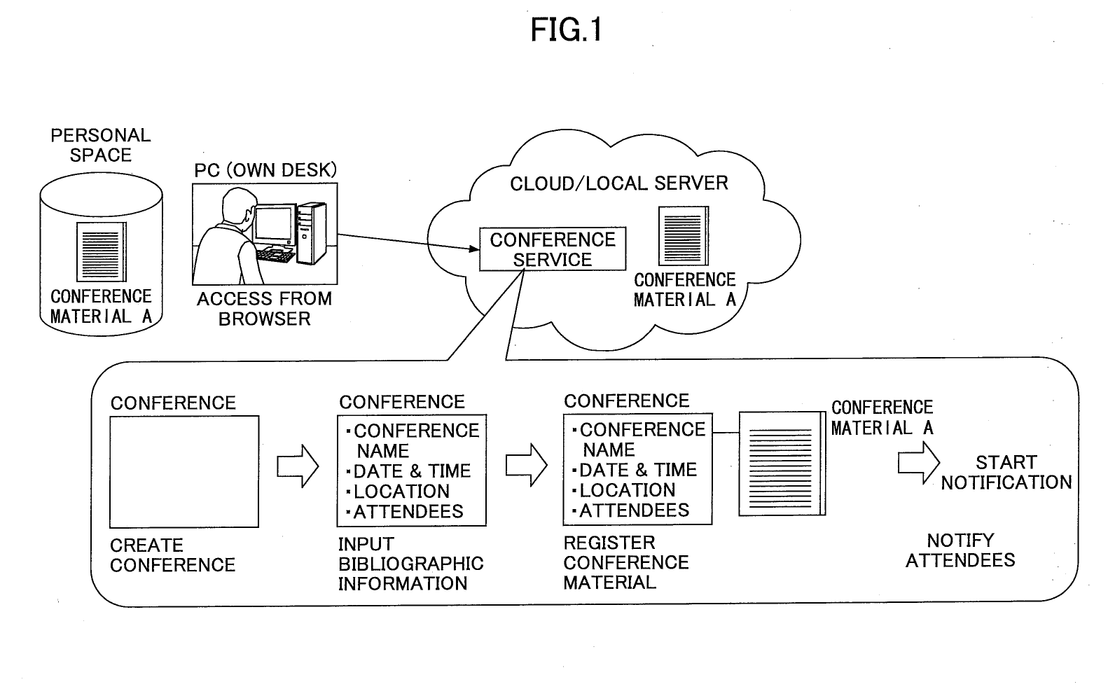

In using a conference support system, users would wish to minimize the preparation time required to hold a conference and start the actual conference right away. However, as illustrated in FIG. 1, generally, users or attendees of a conference have to perform certain preparatory operations such as uploading information (e.g., “Conference Material A” in FIG. 1) that is locally stored in a personal space to a virtual space on a server apparatus (cloud server or local server). Such operations take up time before the actual conference. Further, because the same materials are separately stored in the virtual space and the personal space, users may end up having to manage information at both of these spaces. Accordingly, a communication system is desired that is capable of establishing connection between client apparatuses via a server apparatus through simple operations so that plural users may share content in an environment where the users use electronic devices to hold discussions regarding a particular topic.

Aspects of the present invention relate to configuring a communication system that is capable of (1) easily establishing connection with a network; (2) easily establishing connection with a device; and (3) easily establishing connection with content. For example, such connection may be established through simple user operations (e.g., requiring only one user action).

By configuring a communication system according to an embodiment of the present invention to easily establish connection with a network, even when a user has little or no knowledge of a network, the user may still be able to easily connect an electronic device to a network and user convenience may be improved, for example. Even if the user has knowledge of the network, the time required for establishing connection settings of the electronic device may be reduced, for example.

By configuring a communication system according to an embodiment of the present invention to easily establish connection with a device, communication between devices may be easily started, for example.

By configuring a communication system according to an embodiment of the present invention to easily establish connection with content, content such as a document may be easily accessed, for example.

A communication system according to an embodiment of the present invention is configured to connect a client apparatus to a virtual shared space that is connected to a network via a server apparatus through simple operations. According to aspects of the present embodiment, a person-to-person connection, a location-to-location connection, and a time-to-time connection may be established, for example.

### First Embodiment

[Connection to Network]

In the following, a communication system 1 according to a first embodiment of the present invention for establishing connection with a network is described.

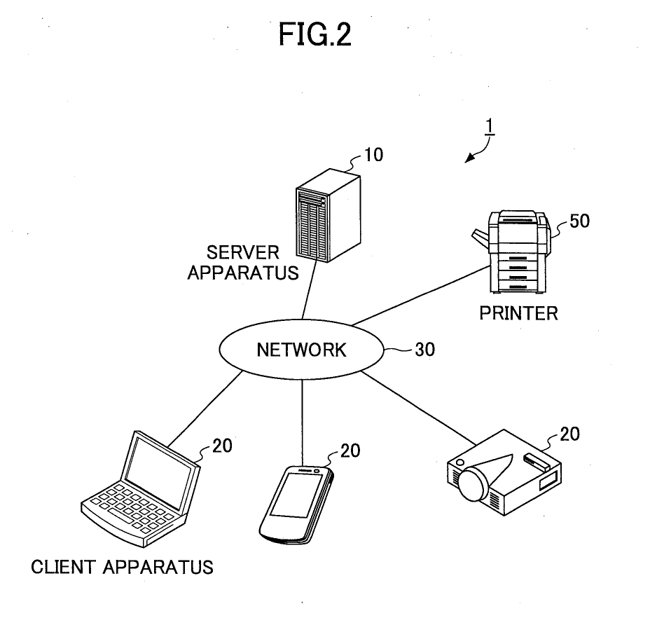

FIG. 2 illustrates an overall configuration of the communication system 1 according to the first embodiment.

(Overall Configuration)

The communication system 1 according to the present embodiment includes a server apparatus 10, a client apparatus 20, and a network 30. It is noted that plural client apparatuses 20 may be connected to the network 30. The client apparatus 20 may be a computer such as a laptop, a PC, a mobile device such as a tablet or a mobile terminal, or a unique device such as a projector, for example. The network 30 may also be connected to a printer 50. The server apparatus 10 may be a cloud server that exists on a public network or a local server such as an intra-company server, for example.

The network 30 may be a wired LAN (local area network), a wireless LAN, or a mobile network such as the 3G/4G network or WiMAX (registered trademark) used by wireless mobile terminals.

(Functional Configuration)

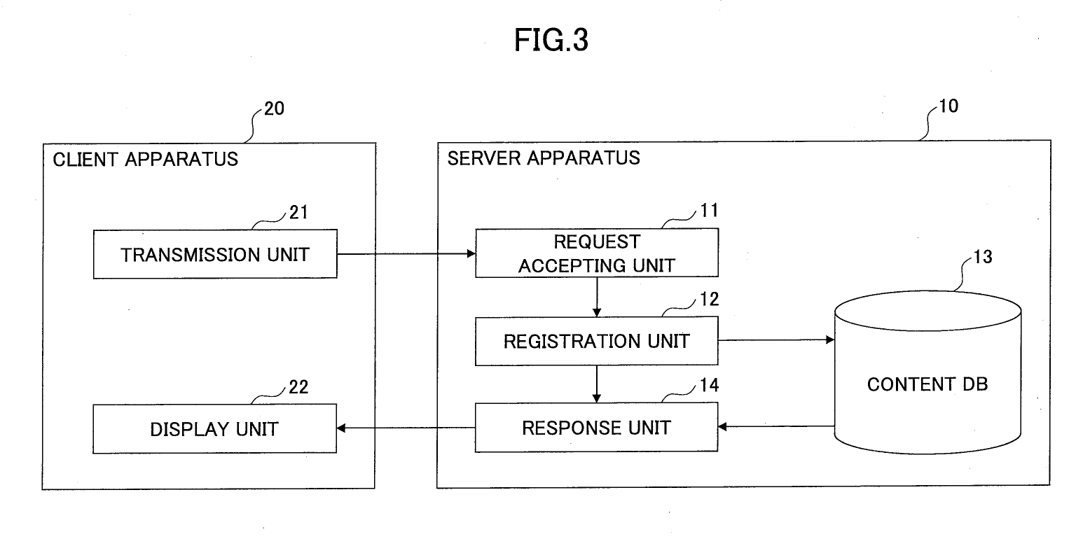

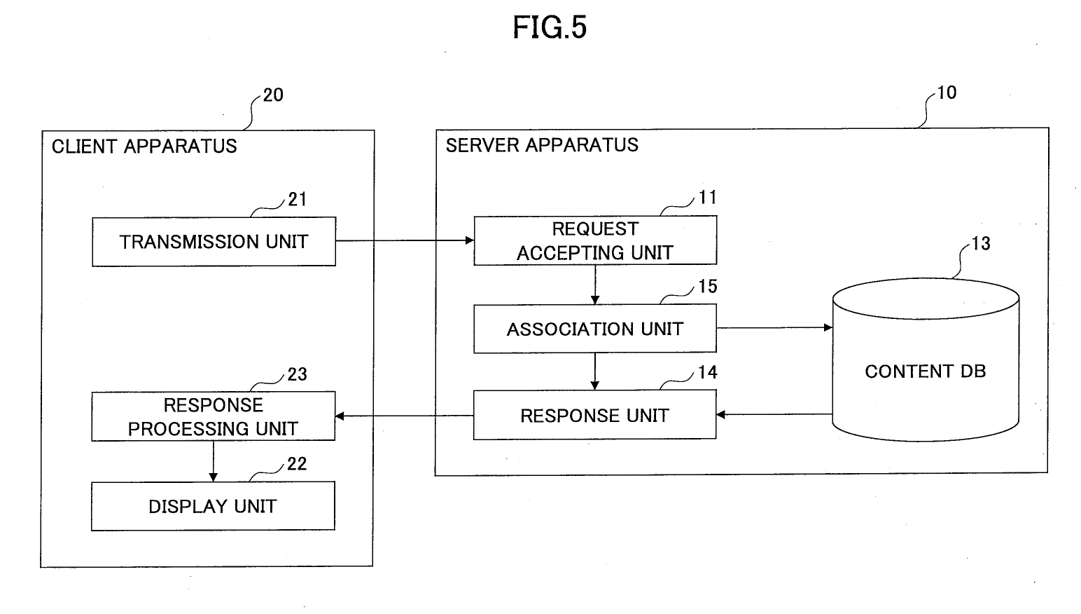

In the following, functional features of the server apparatus 10 and the client apparatus 20 are described. FIG. 3 illustrates functional features of the server apparatus 10 and the client apparatus 20 for implementing a content registration process for registering content in the server apparatus 10. FIG. 5 illustrates functional features of the server apparatus 10 and the client apparatus 20 for implementing a content association process, which is described below in connection with a second embodiment of the present invention.

Referring to FIG. 3, during a content registration process, the server apparatus 10 implements functional features of a request accepting unit 11, a registration unit 12, a content DB (database) 13, and a response unit 14. The client apparatus 20 implements functional features of a transmission unit 21 and a display unit 22.

In the content registration process, the transmission unit 21 transmits content and corresponding attribute information from the client apparatus 20 to the server apparatus 10. For example, the content may be a document printed out by the printer 50 that is connected to the network 30. The attribute information may be embedded in a barcode or a two-dimensional code and may be printed by the printer 50 and attached to the content, for example.

At the server apparatus 10, the request accepting unit 11 receives the content and the attribute information from the client apparatus 20 and passes the received content and attribute information to the registration unit 12. The registration unit 12 registers the content and the attribute information in the content DB 13, and outputs a success/failure status to the response unit 14. When the content and the attribute information are successfully registered, the registration unit 12 outputs a success status. When the registration of the content and the attribute information is unsuccessful, the registration unit 12 outputs a failure status. The response unit 14 transmits the success/failure status to the client apparatus 20.

At the client apparatus 20, the display unit 22 displays the success/failure status. In this way, the user may check whether the content and the attribute information have been successfully registered in the content DB 13.

It is noted that the above content registration process may be implemented using conventional methods. For example, a content registration web page may be provided, and when a user designates a file and presses a registration button, the file may be transmitted to a server apparatus. In another example, an application may be configured to monitor a folder designated by a user, and upon detecting a new file, a file change, or a file deletion, the application may automatically transmit the file to a server apparatus. However, the present invention is not limited to these methods, and may use any means for enabling the content registration process.

### Specific Example

For example, code information may be embedded in a printed document, a user may capture an image of the printed document using a mobile terminal, and information obtained in this manner may be used to start and navigate a conference. For example, address information (e.g., URL) indicating where electronic data corresponding to the printed document is stored may be embedded in barcode information, and by reading the barcode information and obtaining the address information embedded therein, the electronic data corresponding to the printed document may be acquired by accessing the address. In such an example, because electronic data corresponding to the printed document is printed or output, degradation that occurs from copying the actual printed document may be avoided. Also, even when the printed sheet is marked up or has notes inscribed thereon, electronic data of the printed document that is free of such marks and inscriptions may be obtained.

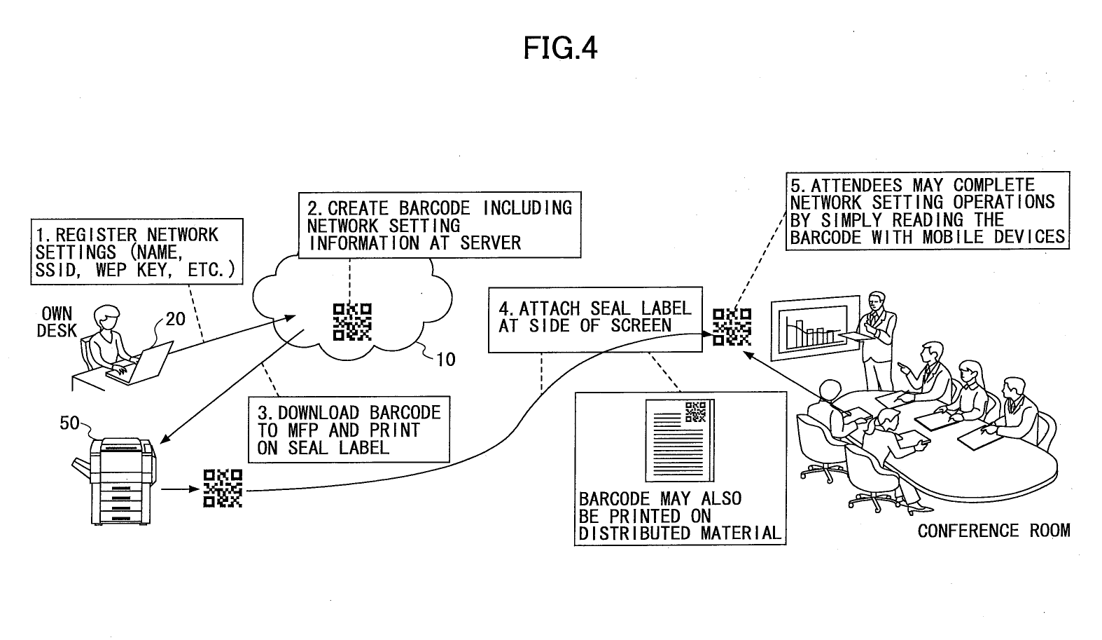

FIG. 4 illustrates an exemplary process of establishing connection with a network using the communication system 1 of the present embodiment.

First, a user logs into the client apparatus (e.g., PC) 20 by inputting a user ID. The user then selects a file to be registered from contents stored in the PC 20, prints out the selected content, and attaches barcode information to the printed sheet. In this example, the following steps are performed:

1. The user preregisters network setting information such as a name, a SSID (service set identifier), and a WEP (wired equivalent privacy) key, in the server apparatus 10.

2. The registered network setting information is embedded in a two-dimensional code. The two dimensional code is generated at the server apparatus 10 (cloud server or local server). It is noted that the network setting information included in the two-dimensional code is encrypted so that the network setting information cannot be identified by simply reading the two-dimensional code with an electronic device. Also, it is noted that the code information used does not necessarily have to be a two-dimensional code and other types of code information such as a barcode may be used as well.

3. The code information is downloaded in a printer (e.g., MFP: multifunction peripheral), and the two-dimensional code is printed on a seal label.

4. The printed seal label may be attached to the side of a screen of a conference room to be used, for example. In other examples, the two-dimensional code may be printed on distributed materials, or the printed seal label may be attached to the distributed materials.

5. Attendees may complete network setting operations by simply having their electronic apparatuses such as mobile phones read the two-dimensional code attached to the screen or distributed materials.

It is noted that before performing the above process, the client apparatus 20 may not be connected to the network 30 and may be unable to obtain information from the server apparatus 10. However, by using the communication system 1 of the present embodiment in the manner described above, network setting operations may be completed through one action by the user and network connection may be established as a result. Also, because the above example merely involves attaching a seal label having code information printed thereon, the client apparatus 20 may be easily connected to the network 30 at a relatively low cost.

### Second Embodiment

[Connection to Device]

In the following, a communication system 1 according to a second embodiment of the present invention for establishing connection with a device is described. FIG. 5 illustrates functional features of the server apparatus 10 and the client apparatus 20 for implementing a content association process. As illustrated in FIG. 5, the server apparatus 10 implements functional features of an association unit 15 to perform the content association process.

During the content association process, the server apparatus 10 implements functional features of the request accepting unit 11, the association unit 15, the content DB 13, and the response unit 14. The client apparatus 20 implements functional features of the transmission unit 21, a response processing unit 23, and the display unit 22.

In the content association process, the user starts an application at the client apparatus 20 and generates a connection request including attribute information such as context information. The generated connection request is passed to the transmission unit 21, and the transmission unit 21 transmits the connection request from the client apparatus 20 to the server apparatus 10.

At the server apparatus 10, the request accepting unit 11 accepts the connection request from the client apparatus 20 and passes the connection request to the association unit 15. The association unit 15 extracts the context information included in the connection request and selects content associated with the context information from the content DB 13. The association unit 15 stores the context information in association with the selected content in the content DB 13, and passes the selected content to the response unit 14. The response unit 14 extracts the context information associated with the selected content from the content DB 13, and transmits the selected content and the associated context information to the client apparatus 20.

At the client apparatus 20, the response processing unit 23 receives the information transmitted from the server apparatus 10, extracts the context information, and passes the context information to the display unit 22. The display unit 22 presents the context information to the user in a visible format using a user interface (UI), for example.

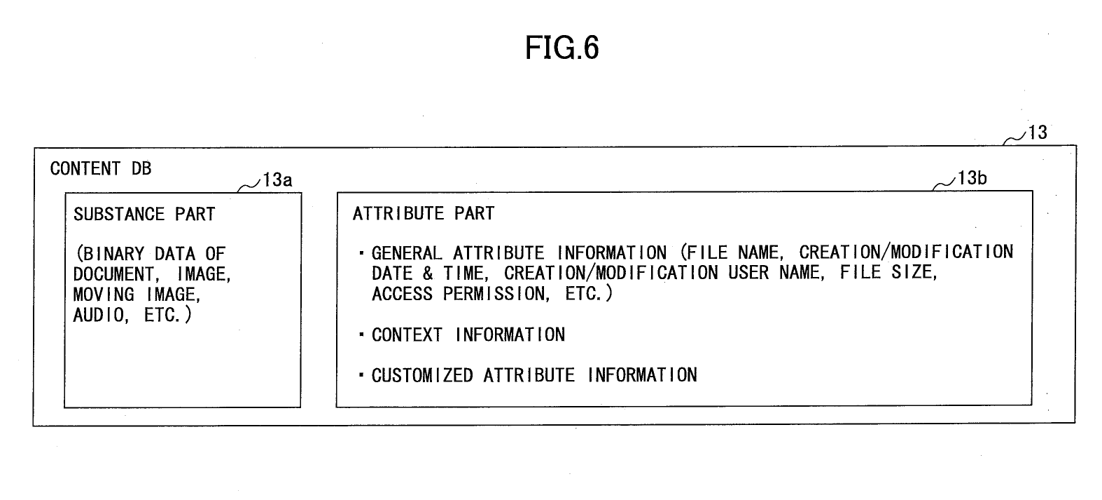

FIG. 6 illustrates an exemplary data configuration of content stored in the content DB 13. As illustrated in FIG. 6, content stored in the content DB 13 include a substantive part 13a and an attribute part 13b. The substantive part 13a includes substantive information such as binary data of a document, an image, a moving image, or audio; and non-substantive information such as electronic data representing objects of the physical world such as people, times, and locations.

The substantive part 13a stores substantive information to be shared by users as binary data. The substantive information may include documents such as word documents and PDF documents, images in the bitmap format or the JPEG (Joint Photographic Experts Group) format, moving images in the MEPG 4 (Moving Picture Experts Group 4) format or the VP8 format, and sound/audio in the MP3 (MPEG Audio Layer-3) format or AAC (Advanced Audio Coding) format, for example. The substantive part 13a does not have to include the non-substantive information representing objects of the physical world such as people, times, and locations.

The attribute part 13b includes general attribute information such as file name, creation/modification time & date, creation/modification user name, file size, access permission; context information; and customized attribute information.

The general attribute information may be equivalent to file attribute information supported by Windows (registered trademark), for example. The general attribute information may be obtained when the client apparatus 20 uploads content to the server apparatus 10 based on a user command. Also, it is noted that general attribute information may not be included in a case where the content corresponds to non-substantive content such as a person, a time, or location, for example.

The context information corresponds to attribute information for storing information to be associated with the content. The context information is described below in greater detail.

The customized attribute information corresponds to specific attribute information defined for a particular content. For example, the customized attribute information may be used for storing information relating to non-substantive information such as a location. In this case, the customized attribute information may include specific information relating to the location such as the location name and the latitude/longitude/altitude of the location. It is noted that connection and information exchange between the server apparatus 10 and the client apparatus 20 may be established using any suitable communication means including web applications based on HTTP (Hypertext Transfer Protocol) communication, web services such as SOAP (Simple Object Access Protocol) or REST (Representational State Transfer), and messaging services such as XMPP (Extensible Messaging and Presence Protocol).

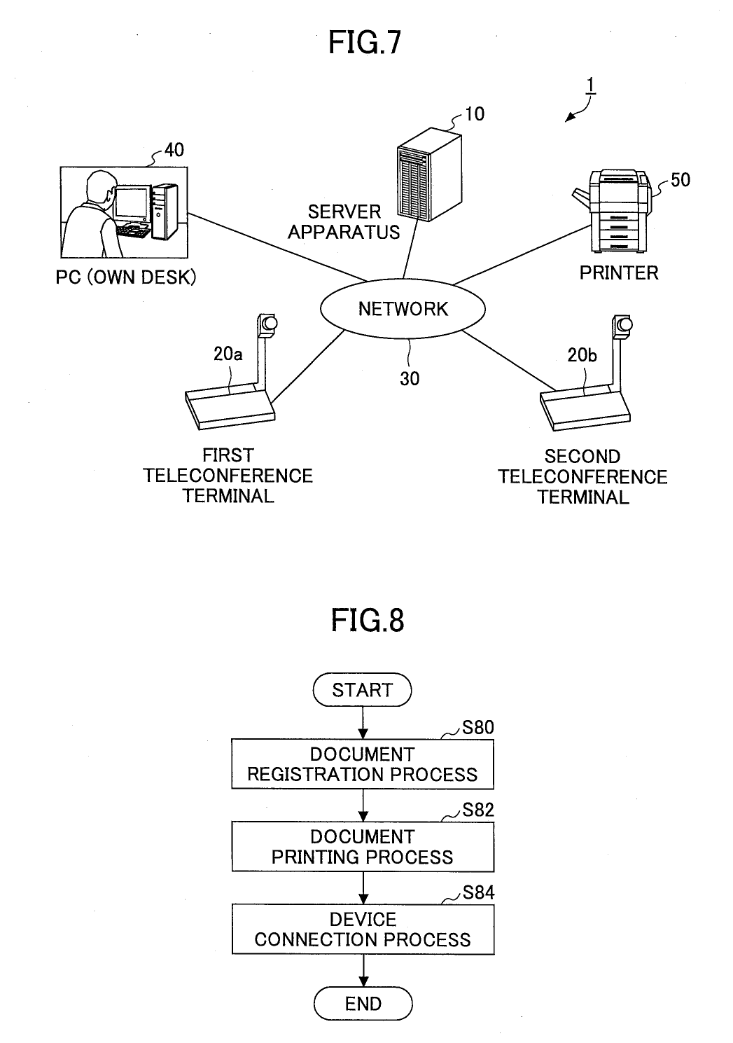

FIG. 7 illustrates an overall configuration of the communication system 1 according to the second embodiment. The communication system 1 of the second embodiment includes the server 10, a first teleconference terminal 20a, a second teleconference terminal 20b, the network 30, a PC 40, and the printer 50. The communication system 1 of the present embodiment is a teleconference system that is configured to establish connection between the first teleconference terminal 20a to be used in a teleconference at location A and the second teleconference terminal 20b to be used in the teleconference at location B. In the following descriptions, the device ID of the first teleconference terminal 20a is denoted as “CID-A”, and the device ID of the second teleconference terminal 20b is denoted as “CID-B”. In the present embodiment, a user may register a document in the server apparatus 10 via the PC 40. The server apparatus 10 manages the registered document, and the printer 50 prints the document.

### Specific Example

FIG. 8 is a flowchart illustrating exemplary process steps implemented by the communication system 1 of the second embodiment.

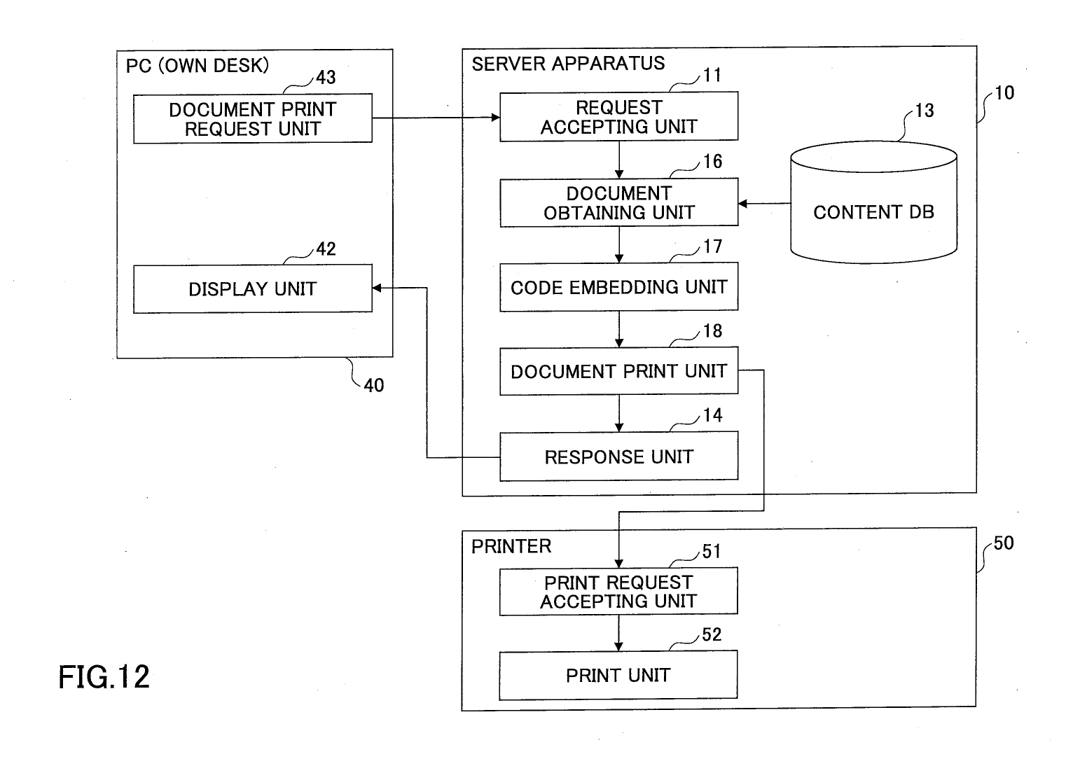

First, in step S80, a document registration process is performed. The document registration process is a specific example of the content registration process, which is described above with reference to FIG. 3, where the content to be registered corresponds to a document. It is noted that the document registration process of the present embodiment may be substantially identical to the content registration process of FIG. 3 so the detailed descriptions thereof are omitted. Then, in step S82, a document printing process is performed. The document printing process involves printing a document on paper in order to establish connection with a device using the printed document. The document printing process is described in greater detail below with reference to FIG. 12.

Then, in step S84, a device connection process is performed. The device connection process is a specific example of the content association process described above with reference to FIG. 5. By performing the above three process steps S80-S84, users may easily establish connection between two devices (client apparatuses), for example.

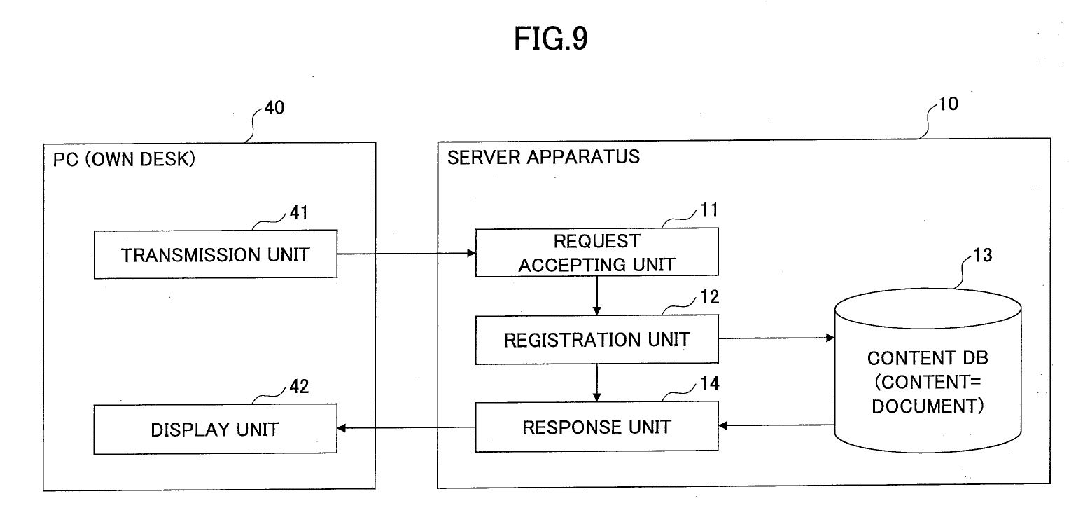

FIG. 9 illustrates functional features of the server apparatus 10 and the PC 40 for implementing the document registration process of step S80. The server apparatus 10 includes the request accepting unit 11, the registration unit 12, the content DB 13, and the response unit 14. The PC 40 includes a transmission unit 41 and a display unit 42. As described above, in the document registration process of step S80, steps identical to the content registration process of FIG. 3 are performed to register a document as content in the content DB 13.

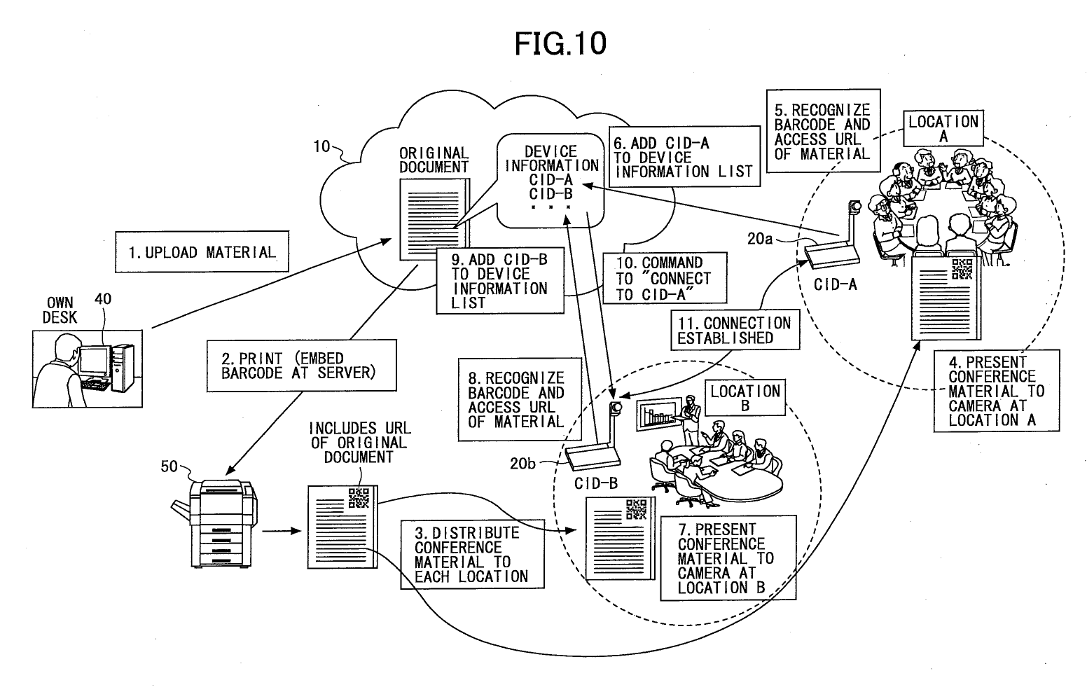

FIG. 10 illustrates exemplary operations of the document registration process. In the illustrated document registration process, the user opens a web application using the PC 40 at his/her own desk, selects a file to be registered, and presses a register button. At the PC 40, the transmission unit 41 transmits the designated file and corresponding attribute information such as the file name, the creation/modification time & date, the creation/modification user, the file size, and access permissions to the server apparatus 10. In operation step 1 of FIG. 10, the PC 40 uploads information (material) to the server apparatus 10.

At the server apparatus 10, the request accepting unit 11 receives the file and the attribute information from the PC 40 and passes the received file and attribute information to the registration unit 12. The registration unit 12 registers the file and the attribute information in the content DB 13 and outputs a success/failure status to the response unit 14. The response unit 14 transmits the success/failure status to the PC 40. In turn, the display unit 42 of the PC 40 displays the success/failure status on a screen of the PC 40.

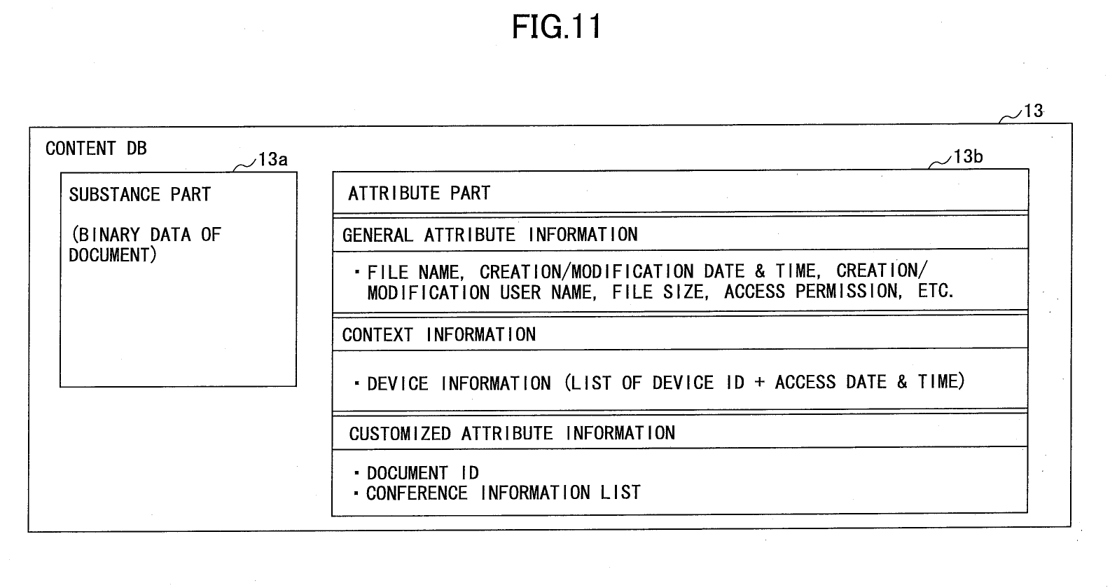

FIG. 11 illustrates an exemplary data configuration of content stored in the content DB 13 of the present embodiment. In FIG. 11, device information is stored as context information, and a document ID and conference information are stored as customized attribute information. The device information and the conference information may be arranged into lists, for example. The device information corresponds to an example of client apparatus identification information of the present invention and includes a device ID indicating the device that has accessed the content and the access time & date when the device made the connection request to access the content. The document ID corresponds to identification information for unambiguously identifying a document within the content DB 13. The conference information includes relevant information such as archival information of a conference that the user wishes to store such as the conference name, start date & time, end date & time, location, attendees, and related documents. Because a given content may be used in plural conferences, the conference information may be stored as a list, for example.

FIG. 12 illustrates functional features of the server apparatus 10, the PC 40, and the printer 50 for performing the document printing process of step S82. The server apparatus 10 includes the request accepting unit 11, the content DB 13, the response unit 14, a document obtaining unit 16, a code embedding unit 17, and a document printing unit 18. The PC 40 includes a document print request unit 43 and the display unit 42. The printer 50 that receives a print request from the server apparatus 10 includes a print request accepting unit 51 and a print unit 52.

In the following the document printing process is described with reference to FIG. 12. The user opens a web application or server using the PC 40 at his/her desk, and selects a document to be printed. Generally, a document that is managed by a server has a document ID assigned thereto. For example, in a case where the URL of the server is “http://doc.com” and the document ID of the selected document is “56781234”, the user may easily access the desired document by opening the following URL using a web browser: http://doc.com ID=56781234.

By opening the above URL, a print button is displayed along with the file name, and the user may start printing the desired document by pressing the print button. At the PC 40, the document print request unit 43 receives a print command and directs the server apparatus 10 to print the document with the document ID 56781234.

At the server apparatus 10, the request accepting unit 11 receives the print request and passes the print request to the document obtaining unit 16. The document obtaining unit 16 obtains the document identified by the document ID “56781234” from the content ID 13, and passes the obtained document to the code embedding unit 17. The code embedding unit 17 creates an image such as a barcode having a character string “http://doc.com ID=56781234” indicating the storage location of the electronic data corresponding to the document embedded therein. The code embedding unit 17 passes the document (content) and the barcode image to the document print unit 18. The document print unit 18 renders the document and converts the rendered image into printer language data such as PCL (Page Description Language) or PS (Post Script) data. The document print unit 18 also renders the barcode image and includes the rendered image in the printer language data. It is noted that the barcode printing location may be designated by the user beforehand. Alternatively, the barcode may be printed at a predetermined location, or a blank portion may be automatically searched and the barcode may be printed on such blank portion, for example. The document print unit 18 transmits the printer language data to the printer 50 and outputs a success/failure status to the response unit 14.

In operation step 2 of FIG. 10, the server apparatus 10 sends a print request to the printer 50 to print the document having the barcode embedded therein on paper, for example. It is noted that the printer 50 may be a printer designated by the user beforehand or a predetermined printer. At the printer 50, the print request accepting unit 51 receives the printer language data from the server apparatus 10, and the print unit 52 executes a printing operation. Meanwhile, at the server apparatus 10, the response unit 14 transmits the success/failure status to the PC 40. At the PC 40, the display unit 42 displays the success/failure status received from the server apparatus 10.

A paper document output by the above-described processes has information indicating the storage location of the document embedded therein in the form of a barcode. The paper document may be distributed as conference material and the user may bring the conference material to the conference location. In operation step 3 of FIG. 10, the paper document as a conference material is distributed at each of the locations A and B. It is noted that although attribute information is embedded into the document using a barcode, the attribute information may be embedded into the document (content) using other forms of embedded information such as a one-dimensional or two-dimensional barcode, a woven pattern, or a digital watermark, for example.

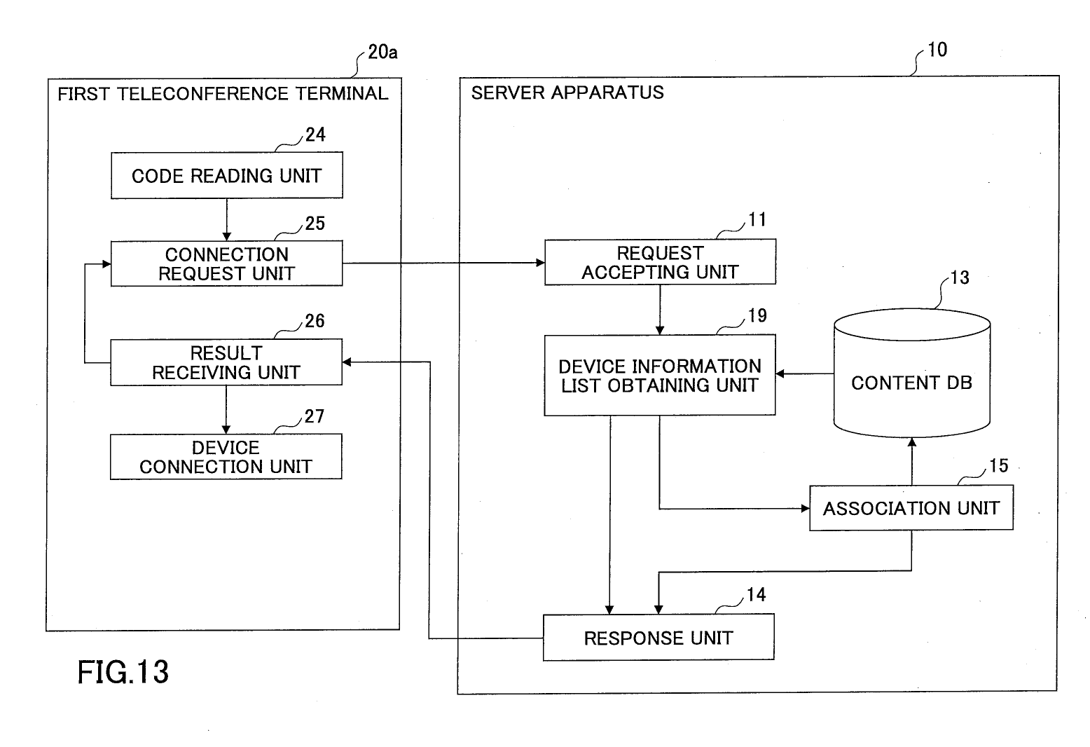

FIG. 13 illustrates functional features of the server apparatus 10 and the first teleconference terminal 20a for implementing the device connection process of step S84 according to the present embodiment. The first teleconference terminal 20a includes a code reading unit 24, a connection request unit 25, a result receiving unit 26, and a device connection unit 27. The server apparatus 10 includes the request accepting unit 11, the content DB 13, the response unit 14, the association unit 15, and a device information list obtaining unit 19. In the following, information exchange operations between the first teleconference terminal 20a and the server apparatus 10 are described. Although similar operations are performed between the second teleconference terminal 20b and the server apparatus 10, descriptions thereof are omitted.

Cameras are installed not only in teleconference terminals but in many other types of electronic devices such as PCs, laptops, tablets, mobile terminals, and projectors. The present embodiment contemplates a case where a user brings in the paper document having the barcode with embedded information and captures an image of the paper document using a camera of the first teleconference terminal 20a. In operation step 4 of FIG. 10, an image of the conference material (paper document) is captured using a camera at location A, and the captured image of the conference material is displayed on a display at a conference room of location A.

It is noted that in an alternative example, a scanner may be used instead of the camera. In this case, the paper document having the barcode embedded therein is scanned by a scanner, and based on the URL included in the barcode information in the scanned image, a corresponding document is obtained and displayed by a display at a conference room of a given location, for example.

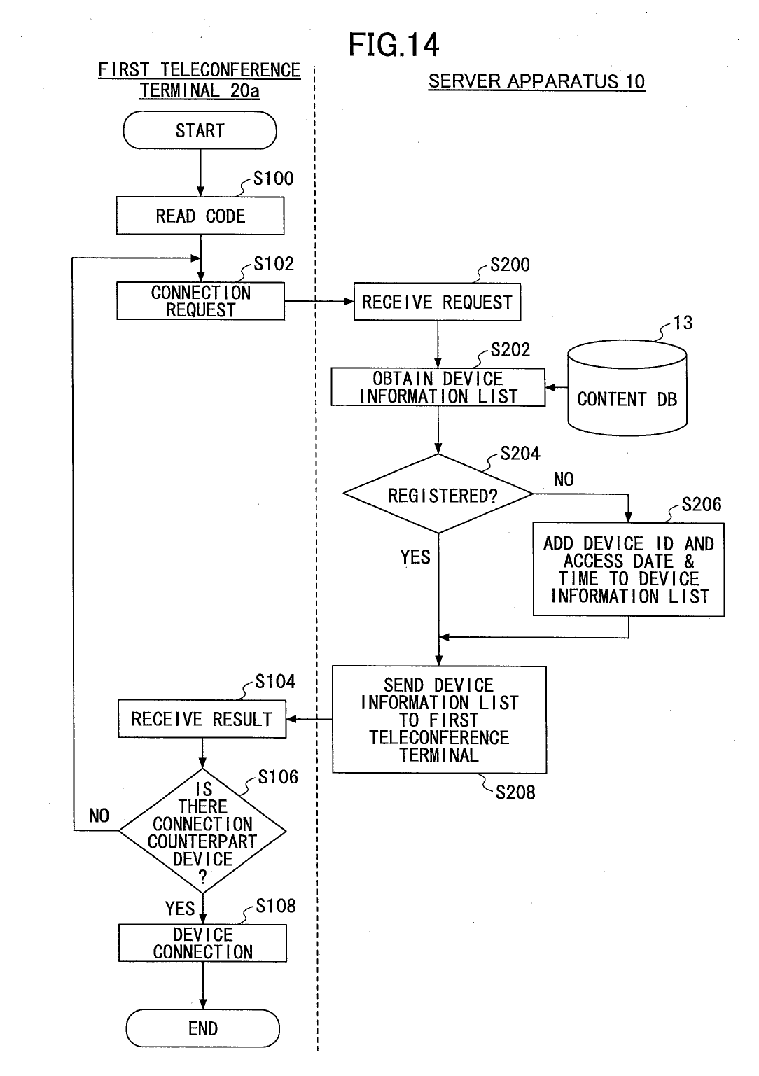

FIG. 14 is a flowchart illustrating exemplary operations of the device connection process according to the present embodiment.

First, in step S100, the code reading unit 24 of the first teleconference terminal 20a recognizes the barcode included in the captured image of the conference material (paper document), decodes information embedded in the barcode, and obtains the URL indicating the storage location of the corresponding document. Next, in step S102, the connection request unit 25 accesses the URL and sends a connection request to the server apparatus 10 to access the document. In this step, the connection request unit 25 also sends the device ID (“CID-A”) identifying the first teleconference terminal 20a. For example, in teleconference systems, call control is often implemented using standards such as the SIP (Session Initiation Protocol). In this case, an ID based on the SIP standard may be sent as the device ID. In operation step 5 of FIG. 10, the first teleconference terminal 20a recognizes the barcode, and uses the URL indicating the storage location of the corresponding document to send a connection request to access the document to the server apparatus 10.

In step S200, the request accepting unit 11 of the server apparatus 10 receives the connection request including the device ID from the first teleconference terminal 20a, obtains a document ID from the URL, and passes the document ID and the device ID to the device information list obtaining unit 19.

In step S202, the device information list obtaining unit 19 obtains a list of device information corresponding to the document ID from the content DB 13.

In step S204, the device information list obtaining unit 19 determines whether the device ID in the connection request is registered in the obtained device information list.

If the device ID is registered, the process proceeds to step S208 where the device information list obtaining unit 19 passes the device information list to the response unit 14.

If the device ID is not registered, the process proceeds to step S206 where the device information list obtaining unit 19 passes the document ID and the device ID to the association unit 15, and the association unit 15 adds the device ID and the access date & time to the device information list of the corresponding content identified by the document ID. For example, in operation steps 6 and 9 of FIG. 10, the respective device IDs “CID-A” and “CID-B” of the first teleconference terminal 20a and the second teleconference terminal 20b are added to the device information list.

Then, the association unit 15 passes device information of one or more connectable devices (device information list) to the response unit 14. In step S208, the response unit 14 transmits the device information list to the first teleconference terminal 20a.

In step S104, the result accepting unit 26 of the first teleconference terminal 20a receives the device information list from the server apparatus 10. Next, in step S106, the result accepting unit 26 determines whether there is a connectable device with which connection could be established based on the device information list received from the server apparatus 10. Specifically, based on the device information list from the server apparatus 10, the result accepting unit 26 may determine whether a device ID other than its own device ID is included in the device information list stored in association with the document in the content DB 13.

In the present embodiment, the server apparatus 10 determines whether there is a connectable device (connectable client apparatus) with which the first teleconference terminal 20a may establish connection, and if there is such a connectable device, the server apparatus 10 transmits a device information list including the device ID of the connectable device to the teleconference terminal 20a.

In the following, a case is considered where the first teleconference terminal 20a and the second teleconference terminal 20b attempt to establish connection and the camera of the first teleconference terminal 20a at location A reads the barcode earlier than the camera of the second teleconference terminal 20b at location B. It is noted that the first teleconference terminal 20a and the second teleconference terminal 20b are exemplary embodiments of the client apparatus 20.

In this case, when the first teleconference terminal 20a receives the device information list from the server apparatus 10, if the camera of the second teleconference terminal 20b at location B has not yet read the barcode, the device ID of the second teleconference terminal 20b may not be included in the device information list received by the first teleconference terminal 20a. In such a case, the first teleconference terminal 20a may have to send a connection request to the server apparatus 10 plural times. In turn, measures are implemented at the server apparatus 10 to determine whether a device ID in a connection request is already registered in the device information list in order to prevent dual registration of a device ID.

If it is determined in step S106 that there is no connectable device with which connection could be established, the process goes back to step S102 where the connection request unit 25 resends a connection request to the server apparatus 10.

If it is determined in step S106 that there is a connectable device with which connection could be established, the process proceeds to step S108 where the device connection unit 27 obtains the device ID of the connectable device and uses the obtained device ID as a key to transmit information for establishing connection with the connectable device. For example, in the case where the SIP standard is used, call control based on the SIP standard may be implemented.

In the above exemplary case where the camera of the first teleconference terminal 20a at location A reads the barcode first, and the camera of the second teleconference terminal 20b at location B reads the barcode thereafter, when the first teleconference terminal 20a first sends a connection request to the server apparatus 10, no connectable device may be found because there is no other device ID registered in the device information list. However, when the second teleconference terminal 20b sends a connection request to the server apparatus 10, the device ID “CID-A” of the first teleconference terminal 20a is already registered in the device information list so that the second teleconference terminal 20b can establish connection with the first teleconference terminal 20a.

For example, in operation step 10 of FIG. 10, upon receiving a connection request from the second teleconference terminal 20b, the server apparatus 10 may find the device ID “CID-A” of the first teleconference terminal 20a corresponding to a device ID other than the device ID “CID-B” of the second teleconference terminal 20b sending the connection request and send the device ID “CID-A” to the second teleconference terminal 20b as information identifying the connectable device with which connection could be established.

In turn, the second teleconference terminal 20b may send a device connection request to the first teleconference terminal 20a, and the first teleconference terminal 20a may establish network connection with the second teleconference terminal 20b. In this way, as illustrated in operation step 11 of FIG. 11, network connection may be established between the first teleconference terminal 20a and the second teleconference terminal 20b.

It is noted that whether to establish connection with a connectable device may be determined by the client apparatus 20 based on the device ID (device information list) received from the server apparatus 10, or the server apparatus 10 may make such determination and send a corresponding command to the client apparatus 20.

As described above, according to an aspect of the second embodiment, a user may establish connection with a desired device through one simple action of holding a paper document over a camera of an electronic device at a conference room, for example. That is, in the present embodiment, a paper document distributed as conference material (content) may be used as a medium to establish connection between client apparatuses in one location or in plural different locations.

According to another aspect of the present embodiment, by embedding code information in a paper document, the code information may be read by an electronic device such as a mobile terminal of a user and the code information obtained in this manner may be used by the electronic device at a conference. Also, by presenting the paper document to a client apparatus that can read the code information embedded in the paper document, connection may be automatically established with other client apparatuses that are using the same document.

It is noted that although a conference material printed on paper is used as a medium in the above-described embodiment, the content used to establish connection between devices is not limited to a paper document. For example, electronic data may be used as the medium instead of a paper document. In this case, for example, when a user displays desired electronic data on a display screen using a tablet or a mobile terminal, a barcode may be displayed at the corner of the display screen, and an image of this barcode may be captured using a camera. In this way, the electronic data may be used as content for establishing connection between devices according to the present embodiment.

Also, it is noted that in the above-described embodiment, attribute information obtained from a desired content includes a document ID as information identifying the desired content. In this case, the association unit 15 may determine whether two or more client apparatuses identified by device IDs may be connected based on the device IDs identifying the client apparatuses and the document ID identifying the desired document. Also, the association unit 15 may determine whether two or more client apparatuses identified by device IDs may be connected based on the device IDs and information indicating a specific barcode information that has been read (e.g., identification information assigned to every barcode).

Also, it is noted that the loop process of returning to step S102 of the connection request unit 25 after the result accepting unit 26 of the client apparatus 20 determines that there is no connectable device may be an infinite loop unless another client apparatus sends a connection request to the server apparatus 10. Thus, in one embodiment, the process may be looped for a first predetermined time period (e.g., 5 seconds) or the loop process may be repeated up to a predetermined number of times (e.g., 5 times), and if no connectable device is found even after the first predetermined time period elapses or after the loop process is repeated the predetermined number of times, the connection request step S102 by the connection request unit 25 may be terminated to end the loop process.

Also, it is noted that if the device information list is permanently stored in the content DB 13, the risk of erroneously establishing connection with a wrong device may be increased because information used in a previous conference may remain in the content DB. Thus, in one embodiment, the server apparatus 10 may determine whether a second predetermined time period (e.g., 1 hour) has elapsed from the time a given set of device information has been registered based on the access time & date, and the server apparatus 10 may automatically delete the device information if the second predetermined time period has already elapsed. In another embodiment, the client apparatus 20 may be configured to send a disconnection request to the server apparatus 10 at a certain timing such as when the client apparatus is disconnected from the network or when the power of the client apparatus is turned off, and the server apparatus 10 may be configured to delete the corresponding device information of the client apparatus from the device information list upon receiving such disconnection request from the client apparatus 20.

### Third Embodiment

[Connection to Content]

In the following, a communication system 1 according to a third embodiment of the present invention for establishing connection with content is described. In the communication system 1 according to the present embodiment, connection may be established between client apparatuses when users make certain gestures using their client apparatuses, and the client apparatuses are able to share contents with each other using a shared space provided by a server apparatus.

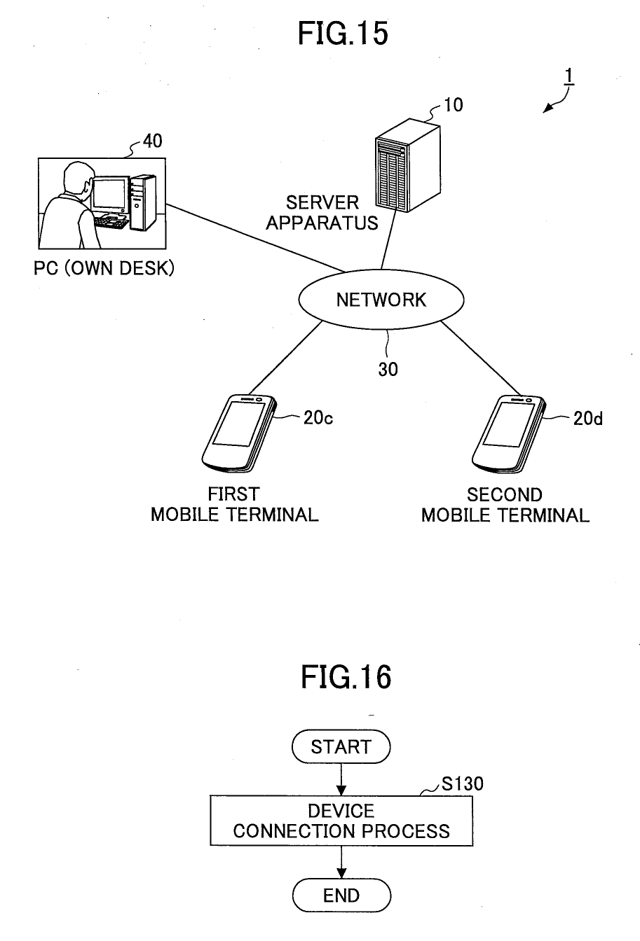

FIG. 15 illustrates an overall configuration of the communication system 1 according to the present embodiment. The illustrated communication system 1 includes the server apparatus 10, a first mobile terminal 20c, a second mobile terminal 20d, the network 30, and the PC 40. The PC 40 may be used for registering location information at the user's desk, for example. The server apparatus 10 is configured to manage information of the location. The first mobile terminal 20c and the second mobile terminal 20d are exemplary embodiments of the client apparatus 20.

### Specific Example

FIG. 16 illustrates an overall process flow of the communication system 1 according to the present embodiment.

In the present embodiment, a device connection process is performed in step S130. It is noted that the device connection process of the present embodiment is a specific example of the content association process described above with reference to FIG. 5. By implementing such a process, users may easily establish connection between their devices. In the present embodiment, instead of using a substantive medium such as a document as content, a non-substantive medium such as a location or a person is used as the content. Thus, a process according to the present embodiment does not include a document printing process as in the second embodiment.

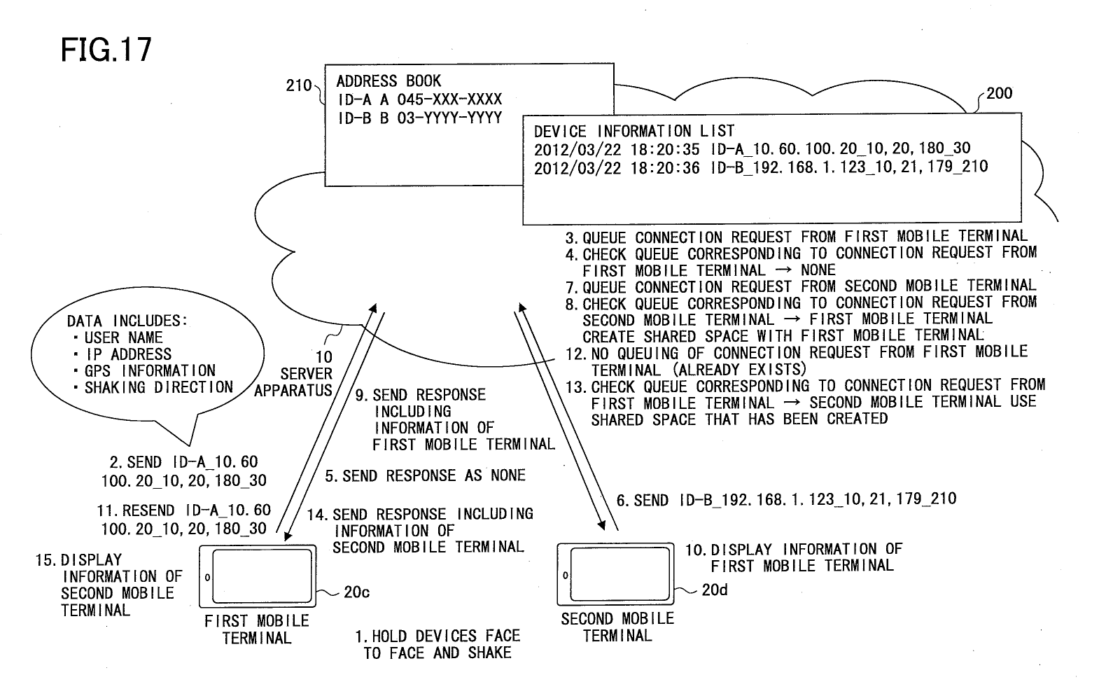

FIG. 17 illustrates exemplary operations of the communication system 1 according to the third embodiment. In operation step 1 of FIG. 17, in order to establish communication between the first mobile terminal 20c of user A and the second mobile terminal 20d of user B, the users A and B hold the first mobile terminal 20a and the second mobile terminal 20b to face opposite each other at substantially 180 degrees and shake the first mobile terminal 20a and the second mobile terminal 20b. Such gesture triggers the start of the device connection process of step S130 illustrated in FIG. 16. In this way, the first mobile terminal 20c of user A and the second mobile terminal 20d of user B may establish communication with each other, and a shared space may be created at the server apparatus 10 that may be used by the users A and B during a collaboration such as a conference between the users A and B.

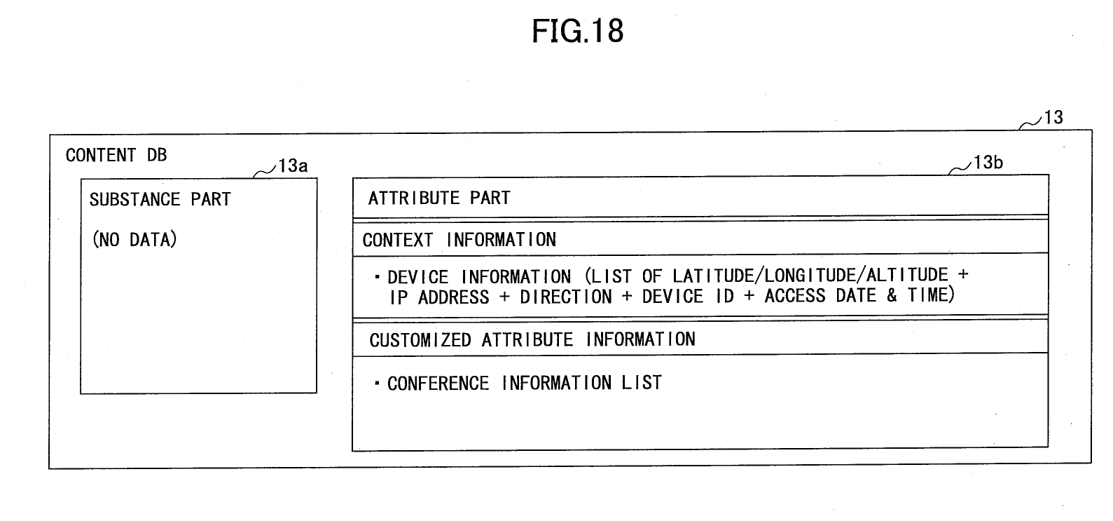

FIG. 18 illustrates an exemplary data configuration of the content DB 13 according to the present embodiment. Unlike a paper document, a location does not provide substantive information. Thus, as illustrated in FIG. 18, no data is stored in the substance part 13a of the content DB 13. Also, no general attribute information is stored in the attribute part 13b because there is no substantive information.

As the context information, device information of a device that has accessed the content is stored in the form of a list. As the customized attribute information, conference information is stored in the form of a list.

The device information includes information identifying a client apparatus (e.g., mobile terminal) that has accessed the corresponding location (content), and may include position information such as the latitude/longitude/altitude, the IP address, direction information, the device ID (user ID), and the access date & time.

The conference information includes archival information relating to a conference that a user wishes to store such as the conference name, the start date & time, the end date & time, location, and attendee list. Because the content may be used at plural conferences, archival information of a conference may be stored in the form of a list.

It is noted that although the device information of the above embodiment includes a device ID, position information, direction information, and an IP address, in certain embodiments, the IP address may be omitted, and only one of position information or direction information may be necessary. Also, a user ID corresponding to the device ID may be included instead of or in addition to the device ID.

In FIG. 17, an exemplary device information list 200 indicates information that is registered in response to the shaking gesture of the first mobile terminal 20c and the second mobile terminal 20d.

In operation step 1 of FIG. 17, the first mobile terminal 20c with the device ID “ID-A” and the second mobile terminal 20d with the device ID “ID-B” are held face to face and shaking gestures are made using these mobile terminals 20c and 20d.

In operation step 2 of FIG. 17, the first mobile terminal 20c with the device ID “ID-A” sends data “ID-A_{—}10.60.100.20_{—}10,20,180_{—}30” to the server apparatus 10. It is noted that “ID-A” of the above data represents the device ID (user ID), “10.60.100.20” represents the IP address, “10,20,180” represents GPS (global positioning system) information, and “30” represent the direction (orientation) of the first mobile terminal 20c. The device ID, the IP address, the GPS information, and the direction information correspond to context information.

In operation step 3 of FIG. 17, the server apparatus 10 queues the context information included in the connection request signaled by the shaking gesture of the first mobile terminal 20c. That is, the server apparatus 10 registers the context information in the device information list 200, and temporarily (e.g., for 5 second) saves the registered information. As a result of this registration operation, the device information list 200 has the information item “2012/03/22 18:20:35 ID-A_{—}10.60.100.20_{—}10,20,180_{—}30” registered at the top of the list. It is noted that “2012/03/22” represents the registration date and “18:20:35” represents the registration time. The registration date and time also correspond to context information.

It is noted that similar connection request recognition and device information registration operations are executed in response to the shaking gesture of the second mobile terminal 20d. Specifically, in operation step 6 of FIG. 17, the second mobile terminal 20d with the device ID “ID-B” sends data “ID-B_{—}192.168.1.123_{—}10,21,179_{—}210” to the server apparatus 10. It is noted that “ID-B” of the above data represents the device ID (user ID), “192.168.1.123” represents the IP address, “10,21,179” represents the GPS information, and “210” represent the direction of the second mobile terminal 20d. In operation step 7 of FIG. 17, the server apparatus 10 queues the context information included in the connection request signaled by the shaking gesture of the second mobile terminal 20d. That is, the server apparatus 10 registers the context information in the device information list 200, and temporarily (e.g., for 5 second) saves the registered information. As a result of this registration operation, the device information list 200 has the information item “2012/03/22 18:20:36 ID-B_{—}192.168.1.123_{—}10,21,179_{—}210” registered as the second item of the list. It is noted that “2012/03/22” represents the registration date of the above context information and “18:20:36” represents the registration time. The registration date and time also correspond to context information.

In the following, exemplary functional features and operations are described for implementing a device connection process using the device information list 200 registered in the above-described manner.

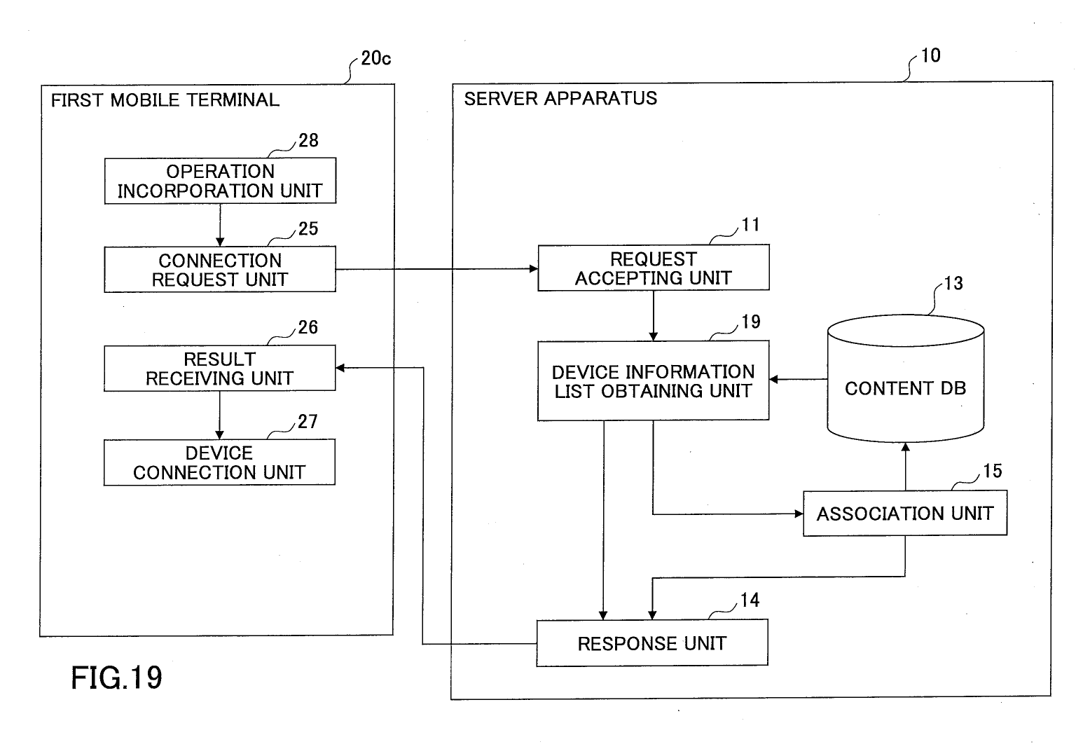

FIG. 19 illustrates functional features of the server apparatus 10 and the first mobile terminal 20c for implementing the device connection process according to the present embodiment. The first mobile terminal 20c includes an operation incorporation unit 28, a connection request unit 25, a result receiving unit 26, and a device connection unit 27. The server apparatus 10 includes the request accepting unit 11, the content DB 13, the response unit 14, the association unit 15, and the device information list obtaining unit 19.

Mobile terminals such as smart phones and tablet PCs have various types of sensors such as GPS sensors, acceleration sensors, and direction sensors installed therein, and application developers may develop applications using the functions of these sensor. The communication system 1 according to the present embodiment is configured to enable easy connection between devices by transmitting information obtained by a client apparatus using these sensors to a server apparatus.

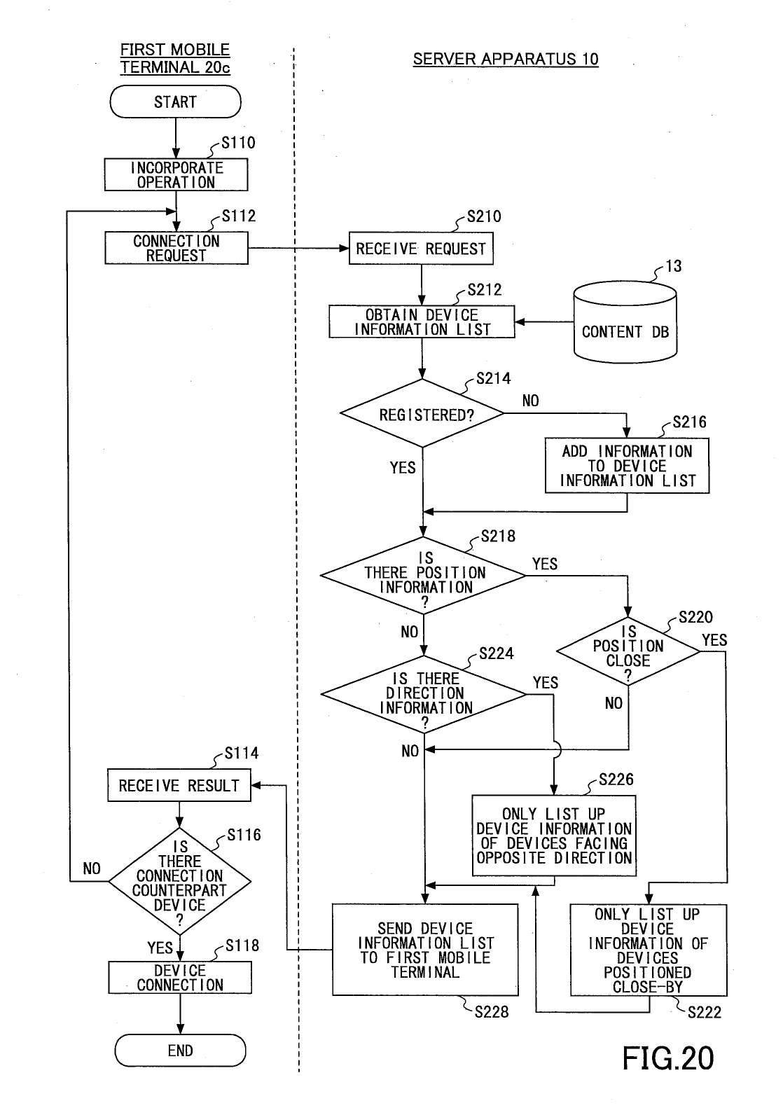

FIG. 20 is a flowchart illustrating exemplary operations of the device connection process according to the present embodiment. It is noted that because operations of the first mobile terminal 20c and the second mobile terminal 20d may be substantially identical, the following descriptions focus mainly on the operations of the first mobile terminal 20a and operations of the second mobile terminal 20d that overlap with those of the first mobile terminal 20c are omitted.

First, the users A and B may arrange the first mobile terminal 20c and the second mobile terminal 20d to face each other and have these terminals vibrate in up-down directions (shaking gesture). In this way, the applications installed in these terminals may be activated. In step S110 of FIG. 20, the operation incorporation unit 28 incorporates the operation (gesture) of the first mobile terminal 20c (corresponding to operation step 1 of FIG. 17).

That is, an acceleration sensor installed in the first mobile terminal 20c detects the up-down vibration. At this time, the first mobile terminal 20c may obtain latitude/longitude/altitude position information from a GPS sensor and the direction (orientation) of the first mobile terminal 20c from a direction sensor. Also, the first mobile terminal 20c obtains the IP address used in the current connection. Further, if a user ID corresponding to the first mobile terminal 20c is established, the user ID is obtained as well.

In step S112, the connection request unit 25 sends a connection request including the position information, direction information, IP address, and user ID (and/or device ID) obtained in the above-described manner to the server apparatus 10 (corresponding to operation step 2 of FIG. 17). It is noted that a client apparatus transmitting a connection request may be identified by at least one of a device ID or a user ID of the client apparatus. Although a device ID is included in the connection request described below as an example, the device ID may be replaced by a user ID.

In step S210, the request accepting unit 11 of the server apparatus 10 receives the connection request including the position information, the direction information, the IP address, and the device ID from the first mobile terminal 20c, and passes the received information to the device information list obtaining unit 19.

In step S212, the device information list obtaining unit 19 searches the content DB 13 using the latitude/longitude/altitude position information to identify the corresponding location, and obtains the device information list associated with this location.

In step S214, the device information obtaining unit 19 determines whether the IP address and device ID included in the received connection request is already registered in the obtained device information list. If the above information is not registered in the device information list, in step S216, the device information obtaining unit 19 passes the device information included in the connection request to the association unit 15, and the association unit 15 adds the device information to the device information list (corresponding to operation step 3 of FIG. 17). It is noted that in one embodiment, once it is determined in step S214 that the device ID is already registered in the device information list, the determination as to whether the IP address is registered in the device information list may be omitted.

Next, in step S218, the association unit 15 checks whether position information is included in the information transmitted from the first mobile terminal 20c. It is noted that the GPS function of the first mobile terminal 20c may be turned on/off as desired. The GPS may be turned off to conserve energy and prolong the battery life of the first mobile terminal 20c, for example. If position information is included, the process proceeds to step S220 where the association unit 15 compares the position information from the first mobile terminal 20c with each position information entry included in the device information list to determine whether the corresponding positions are close to each other. If it is determined that the positions are close, in step S222, the association unit 15 extracts from the device information list the device information with the position information determined to be close and includes the extracted device information in a list. That is, the association unit 15 lists up only the device information of one or more devices that are determined to be positioned close to the first mobile terminal 20c.

If position information is not obtained from the GPS sensor of the first mobile terminal 20c, the process proceeds to step S224 where the association unit 15 compares the direction information obtained from the first mobile terminal 20c with each direction information entry included in the device information list to determine whether the corresponding directions oppose each other at substantially 180 degrees (e.g., 30° and 210°). In step S226, the association unit 15 extracts from the device information list only the device information with the direction information determined to correspond to an opposing direction and includes the extracted device information in a list. That is, the association unit 15 lists up only the device information of one or more devices that are determined to be facing opposite the first mobile terminal 20c. It is noted that two devices may be determined to be facing opposite each other when their directions form an opposing angle of 180±α degrees (where α represents a predetermined value).

In step S228, if device information is extracted from the above-described process steps, the response unit 14 transmits a list including the extracted device information to the first mobile terminal 20c. If no device information is extracted from the above-described process steps, the response unit 14 transmits an empty list to the first mobile terminal 20c.

In step S114, the result receiving unit 26 of the first mobile terminal 20c receives the resulting list from the server apparatus 10.

In step S116, the result receiving unit 26 determines whether device information is included in the list (i.e., whether there is a connectable device), and if there is no device information (no connectable device), the process goes back to step S112 where the connection request unit 25 resends a connection request including the position information and/or the direction information, IP address, and the device ID to the server apparatus 10.

If it is determined in step S116 that device information is included in the list (i.e., there is a connectable device), the process proceeds to step S118 where the result receiving unit 25 passes the device information list to the device connection unit 27 and the device connection unit 27 establishes connection with the corresponding device. In one embodiment, the device connection unit 27 may open a specific port to enable exchange of requests and responses with the connectable device. In another embodiment, the device connection unit 27 may push information to the server apparatus 10, periodically check whether relevant information is available at the server apparatus 10 at predetermined time intervals, and download the information when it becomes available.

It is noted that in the above-described example, a determination is made in step S218 as to whether position information is available, and if no position information is available, the direction information is referenced. However, the present embodiment is not limited to the above example and various alternative process steps may be implemented to determine whether plural client apparatuses may be connected to each other using at least one of position information or direction information.

Also, it is noted that the loop process at the client apparatus (first mobile terminal 20c) of the present embodiment is similar to the loop process illustrated in FIG. 14. That is, the loop process is for resending a connection request to the server apparatus 10 in a case where device information of a connectable device is not registered in the server apparatus 10. The loop process of the present embodiment may similarly be arranged to end when a connectable device is not found even after a predetermined time period elapses or after a connection request is resent a predetermined number of times, for example. Further, as in the second embodiment, the device information of the device information list at the server apparatus 10 of the present embodiment may be arranged to be retained for a predetermined time period and may be deleted from the database after the predetermined time period elapses, for example.

In the following, the above-described processes are described with reference to visual illustrations of FIG. 17.

First, a case is considered where only the first device information entry in the device information list 200 (device information of the connection request from the first mobile terminal 20c) is stored.

In this case, in operation step 4 of FIG. 17, the server apparatus 10 checks if there is a queue corresponding to the connection request from the first mobile terminal 20c. At this point, because the second device information item of the device information list 200 is not yet registered, it is determined that there is no queue corresponding to the connection request from the first mobile terminal 20c. Thus, in operation step 5 of FIG. 17, the server apparatus 10 sends a response indicating “no corresponding device (none)” to the first mobile terminal 20c.

Next, a case is considered where the first device information entry and the second device information entry (device information of the connection request from the first mobile terminal 20c and device information of the connection request from the second mobile terminal 20d) are stored in the device information list 200.

In this case, in operation step 8 of FIG. 17, the server apparatus 10 checks if there is a queue corresponding to the connection request from the second mobile terminal 20d (ID-B). In the present example, the server apparatus 10 determines whether there is device information having GPS information representing a position within a predetermined range from the position of the second mobile terminal 20d (ID-B), or whether there is device information having direction information representing a direction 180 degrees opposite the direction of the second mobile terminal 20d (ID-B). Based on such determination, the server apparatus 10 determines that the connection request from the second mobile terminal 20d (ID-B) corresponds to the connection request from the first mobile terminal 20c (ID-A). In turn, the server apparatus 10 creates a shared space for the first mobile terminal 20c and the second mobile terminal 20d.

In operation step 9 of FIG. 17, the server apparatus 10 sends a response including device information of the first mobile terminal (ID-A) to the second mobile terminal 20d (ID-B).

In operation step 10 of FIG. 17, the second mobile terminal 20d with the device ID “ID-B” displays the device information of the first mobile terminal 20c with the device ID “ID-A”.

It is noted that after the first mobile terminal 20c (ID-A) receives the response “no corresponding device (none)” from the server apparatus 10 in operation step 5 of FIG. 17, the first mobile terminal 20c (ID-A) may repeat the step of sending the data “ID-A_{—}10.60.100.20_{—}10,20,180_{—}30” to the server apparatus 10 for five seconds, for example (operation step 11 of FIG. 17).

In operation step 12 of FIG. 17, the server apparatus 10 does not queue the data included in the connection request resent from the first mobile terminal 20c because the data is already registered.

In operation step 13 of FIG. 17, the server apparatus 10 checks if there is a queue corresponding to the connection request from the first mobile terminal (ID-A). In the present example, the server apparatus 10 determines whether there is device information having GPS information representing a position within a predetermined range from the position of the first mobile terminal 20c (ID-A), or whether there is device information having direction information representing a direction 180 degrees opposite the direction of the first mobile terminal 20c (ID-A). Based on such determination, the server apparatus 10 determines that the connection request resent from the first mobile terminal 20c (ID-A) corresponds to the connection request from the second mobile terminal 20d (ID-B). Because the server apparatus 10 has already created a shared space for the first mobile terminal 20c and the second mobile terminal 20d, the server apparatus 10 does not create a new space in this case.

In operation step 14 of FIG. 17, the server apparatus 10 sends a response including the device information of the second mobile terminal 20d (ID-B) to the first mobile terminal 20c (ID-A).

In operation step 15 of FIG. 17, the first mobile terminal 20c (ID-A) displays the device information of the second mobile terminal 20d (ID-B).

As can be appreciated from the above descriptions, in the present embodiment, connection may be established between client apparatuses by simply making certain gestures using these client apparatuses and content may be shared by these client apparatuses using a shared space provide by a server apparatus.

Further, in the present embodiment, the content shared at the shared space provided by the server apparatus is represented by link information indicating an information source of the content. That is, the content itself is not stored in the shared space, but the server apparatus manages the content based on link information of the content such as the storage location and other relevant information (e.g., address indicating the storage area of the content, URL indicating information relating to the content, etc.). Thus, the content does not have to be uploaded or downloaded and data management may be simplified.

It is noted that although an example where users are prompted to shake their devices is described above, other various gestures such as throwing the devices, hitting the devices, or superposing or stacking the devices one on top of the other may be used as gestures for connecting the devices in the present embodiment. Also, it is noted that although mobile terminals are illustrated as exemplary client apparatuses in the above descriptions, the client apparatuses may correspond to other types of devices. For example, the client apparatuses may correspond to different devices such as a projector and a mobile, and connection between these devices may be triggered by placing the mobile terminal in contact with the projector or holding the mobile terminal over the projector without causing contact.

Also, the server apparatus 10 may be configured to manage an address book 210 in addition to the device information list 200. For example, in FIG. 17, the device ID of a device, the user name of the device user, and the phone number of the device user are stored in the address book 210.

### Fourth Embodiment

[Connection to Content]

In the following, a fourth embodiment corresponding to a modified embodiment of the third embodiment for establishing connection with a device and content is described. As in the third embodiment, in the communication system 1 according to the fourth embodiment, when users make a predetermined gesture using their client apparatuses, connection may be established between the client apparatuses in response to such gesture, and the client apparatuses may share content with each other using a shared space provided by a server apparatus.

It is noted that the overall configuration of the communication system 1 according to the fourth embodiment may be identical to that of the third embodiment as illustrated in FIG. 15 so that descriptions thereof are omitted. Also, functional features of the communication system 1 according to the fourth embodiment for implementing a device connection process may be identical to the functional features of the third embodiment illustrated in FIG. 19 so that descriptions thereof are also omitted.

### Specific Example

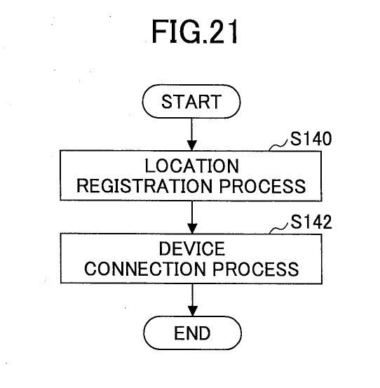

FIG. 21 is a flowchart illustrating an overall process operations of the communication system 1 according to the fourth embodiment.

According to the fourth embodiment, in step S140, a location registration process is performed. The location registration process is an exemplary specific embodiment of a content registration process performed by the registration unit 12 of the server apparatus 10 illustrated in FIG. 3 where the content corresponds to a location or a person (person using a mobile terminal). In the following, an exemplary case where the content corresponds to a location is described.

Next, in step S142, a device connection process is performed. The device connection process is a specific example of the content association process described above with reference to FIG. 5. By implementing the above two processes, users may easily establish connection between devices. In the present embodiment, instead of using a substantive medium such as a document as content, a non-substantive medium such as a location or a person is used as the content. Thus, a process according to the present embodiment does not include a document printing process as in the second embodiment.

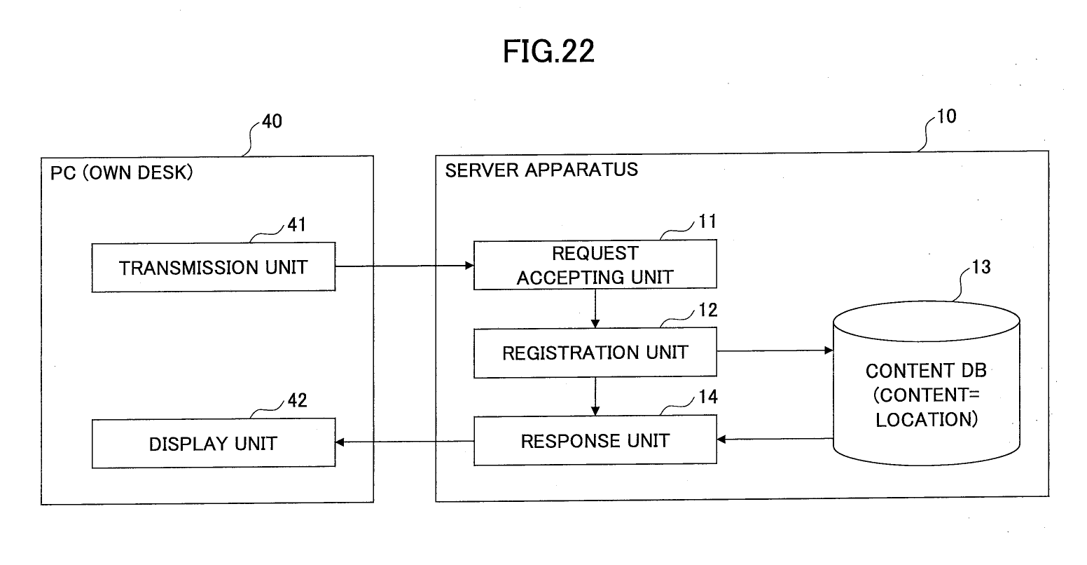

FIG. 22 illustrates functional features of the server apparatus 10 and the PC 40 for implementing the location registration process of step S140. The server apparatus 10 includes the request accepting unit 11, the registration unit 12, the content DB 13, and the response unit 14. The PC 40 includes the transmission unit 41 and the display unit 42. In the location registration process, the user opens a web application using the PC 40 at his/her own desk, inputs information on a location (location name and latitude/longitude/altitude position information) as content to be registered, and presses a register button, for example.

In turn, the transmission unit 41 transmits the input location information (location name and latitude/longitude/altitude position information) to the server apparatus 10.

At the server apparatus 10, the request accepting unit 11 receives the location name and position information and passes the received information to the registration unit 12. The registration unit 12 registers the location name and the position information as customized attribute information in the content DB 13, and outputs a success/failure status to the response unit 14. In turn, the response unit 14 sends the success/failure status to the PC 40. At the PC 40, the display unit 42 displays the success/failure status on the screen of the PC 40.

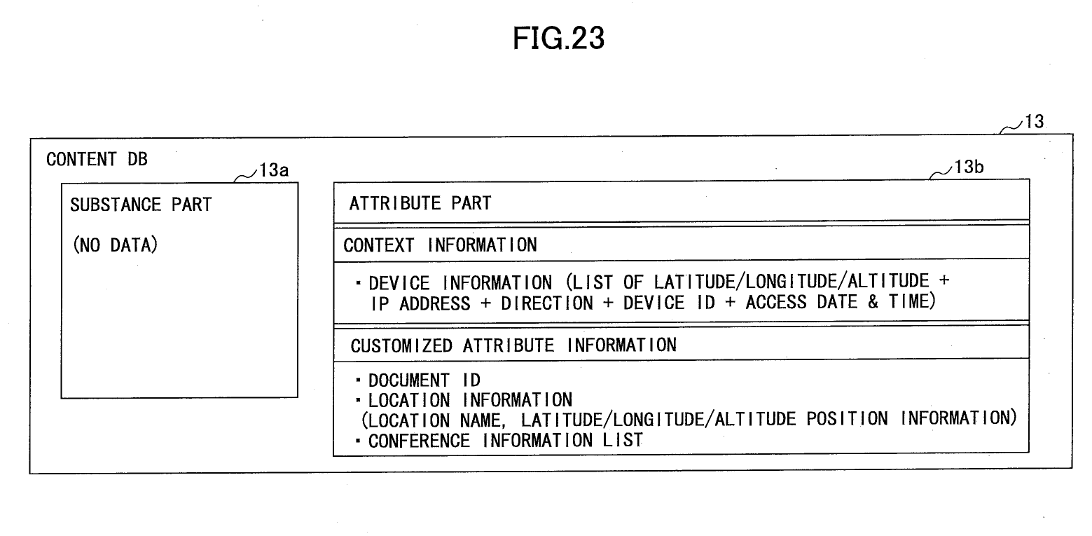

FIG. 23 illustrates an exemplary data configuration of content registered in the content DB 13 by the location registration process of step S140. It is noted that unlike a document, a location provides no substantive information. Accordingly, no data is stored in the substance part 13a of the content DB 13 in the present example. Also, no general attribute information is stored in the attribute part 13b of the content DB 13 in the present example.

As the context information, device information is stored in the form of a list. As the customized attribute information, a location ID, location information, and conference information are stored. The conference information may be stored in the form of a list. The device information corresponds to information on a device (client apparatus) that has accessed the location, including the latitude/longitude/altitude position information of the device, the IP address of the device, the direction of the device, the device ID (user ID), and the access date & time, for example.

The location ID corresponds to information for unambiguously identifying the location within the content DB 13. The conference information may include archival information relating to a conference that a user may wish to store such as the conference name, start date & time, end date & time, location, attendee list, etc. Because the location may be used at plural conferences, the conference information is preferably stored as a list.

It is noted that in some embodiments the device information may only include a device ID and position information, and the direction information and the IP address may be omitted. In other embodiments, a user ID identifying the user of the device may be included instead of or in addition to the device ID.

In the present embodiment, to establish communication between the first mobile terminal 20 of user A and the second mobile terminal 20d of user B, predetermined gestures are made using the first mobile terminal 20c and the second mobile terminal 20d. In turn, these gestures trigger the start of the device connection process of step S142 illustrated in FIG. 21.

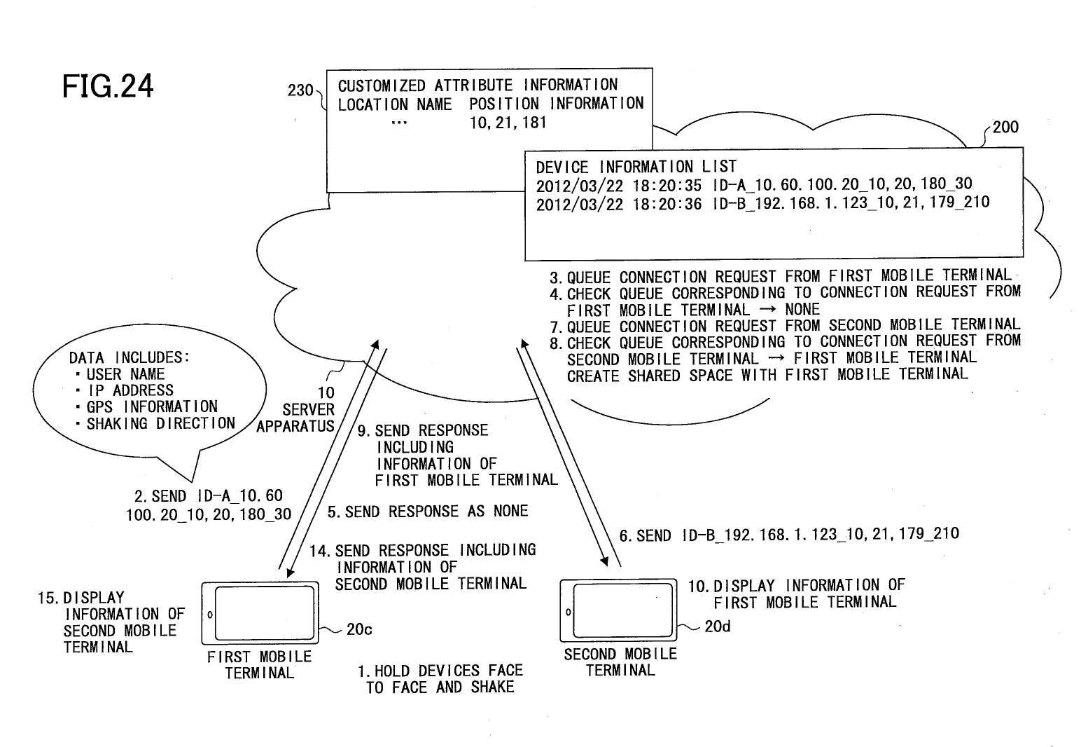

FIG. 24 illustrates exemplary operations of the communication system according to the present embodiment.

In operation step 1 of FIG. 24, the first mobile terminal 20 with the device ID “ID-A” and the second mobile terminal 20d with the device ID “ID-B” are arranged to face opposite each other and shaking gestures are made with these mobile terminals.

In operation step 2 of FIG. 24, the first mobile terminal 20c with the device ID “ID-A” sends data “ID-A_{—}10.60.100.20_{—}10,20,180_{—}30” to the server apparatus 10. It is noted that “ID-A” of the above data represents the device ID (user ID), “10.60.100.20” represents the IP address, “10,20,180” represents the GPS information, and “30” represent the direction (orientation) of the first mobile terminal 20c. The device ID, the IP address, the GPS information, and the direction information correspond to context information.

In operation step 3 of FIG. 24, when the server apparatus 10 receives the connection request signaled by the above device gesture of the first mobile terminal 20c, the server apparatus 10 searches the content DB 13 using the context information included in the connection request to find content corresponding to the position information. That is, the server apparatus 10 searches the content DB 13 for content having customized attribute information including position information representing a position that is the same as or close to (e.g., within a predetermined range of) the position represented by the position information of the context information included in the connection request. If a corresponding content is found, the server apparatus 10 registers the location name and position information of the corresponding content in a customized information list 230. The server apparatus 10 also registers the received context information and the registration date & time in the device information list 200 of the corresponding content. As a result of this registration operation, the device information list 200 has the information “2012/03/22 18:20:35 ID-A_{—}10.60.100.20_{—}10,20,180_{—}30” registered at the top of the list. It is noted that “2012/03/22” represents the registration date and “18:20:35” represents the registration time. The registration date and time also correspond to context information.

Next, the server apparatus 10 determines whether the device information list 200 having the context information from the first mobile terminal 20c registered therein includes other context information. In the present example, context information of another device (connectable client apparatus) is not yet registered in the device information list 200 at the time the connection request from the first mobile terminal 20c is received. Accordingly, the server apparatus 10 determines that there is no device information of a connectable device and sends a corresponding response to the first mobile terminal 20c (operation step 5 of FIG. 24).

In the following, operations concerning a connection request from the second mobile terminal 20d are described. It is noted that connection request recognition and device information registration operations similar to those executed in response to the connection request from the first mobile terminal 20c are executed in response to the connection request from the second mobile terminal 20d. Specifically, in operation step 6 of FIG. 24, the second mobile terminal 20d with the device ID “ID-B” sends data “ID-B_{—}192.168.1.123_{—}10,21,179_{—}210” to the server apparatus 10. It is noted that “ID-B” of the above data represents the device ID (user ID), “192.168.1.123” represents the IP address, “10,21,179” represents the GPS information, and “210” represent the direction of the second mobile terminal 20d.

In operation step 7 of FIG. 24, the server apparatus 10 searches the content DB 13 for corresponding content based on the context information included in the connection request signaled by the shaking gesture of the second mobile terminal 20d and registers the context information in the device information list 200 of the corresponding content. As a result of this registration operation, the device information list 200 has the information “2012/03/22 18:20:36 ID-B_{—}192.168.1.123_{—}10,21,179_{—}210” registered as the second item on the list. It is noted that “2012/03/22” represents the registration date of the above context information and “18:20:36” represents the registration time. The registration date and time also correspond to context information.

Next, the server apparatus 10 determines whether the device information list 200 having the context information from the second mobile terminal 20d registered therein includes other context information. In the present example, context information of the first mobile terminal 20c is already registered in the device information list 200. Accordingly, the server apparatus 10 determines that the first mobile terminal 20c corresponds to a connectable device with which the second mobile terminal 20d may establish connection and sends information of the first mobile terminal 20c (e.g., IP address, device ID, user ID, etc.) to the second mobile terminal 20d (operation step 9 of FIG. 24).

Then, in operation step 10 of FIG. 24, the second mobile terminal 20d displays the information of the first mobile terminal 20c. It is noted that when the first mobile terminal 20c resends a connection request to the server apparatus 10 thereafter, context information of the first mobile terminal 20c as well as the context information of the second mobile terminal 20d would be registered in the device information list 200 of the server apparatus 10. Accordingly, the server apparatus 10 may send the information of the second mobile terminal 20d as a connectable device to the first mobile terminal 20c in such case (operation step 14 of FIG. 24.

As can be appreciated from above, in the communication system 1 according to the present embodiment, client apparatuses associated with a given location may be connected with each other based on preregistered information of the location. According to an aspect of the present embodiment, users may establish connection between their client apparatuses by simply going to the preregistered location (e.g., conference room) and making predetermined gestures using their client apparatuses, and the client apparatuses may share content with each other using a shared space provided by a server apparatus.

Also, in the present embodiment, the content in the shared space provided by the server apparatus is represented by link information indicating the information source of the content. That is, the server apparatus does not store the content itself in the shared space but manages the content using link information relating to the storage location of the content and other relevant information (e.g., address indicating the storage area of the content, URL indicating information relating to the content, etc.). Thus, the content does not have to be uploaded or downloaded, and data management may be simplified, for example.

It is noted that although an example where users shake their devices is described above, the predetermined gesture for triggering connection may include other various device gestures such as throwing the device, hitting the devices, and superposing or stacking the devices one over the other, for example. Also, although the client apparatuses correspond to mobile terminals in the above example, the client apparatuses may be other types of devices as well. For example, the client apparatuses may correspond to a mobile terminal and a projector, and connection between the devices may be triggered when the mobile terminal comes into contact with the projector or when the mobile terminal is held over the projector without coming into contact.

### Modified Embodiment

In the communication system 1 according to the third embodiment, connection between client apparatuses is established by the gestures of two client apparatuses. In the following, a modified embodiment is described for establishing connection between three or more client apparatuses that make connection requests through predetermined gestures, where two or more of the client apparatuses are at the same location and at least another one of the client apparatuses is at a nearby location (e.g., conference room) and makes the predetermined gesture at substantially the same time in the same direction.

In the former situation (where the client apparatuses are at the same location), since the users of the client apparatuses are at the same location, connection may be readily established between the client apparatuses. In the latter situation, however, since the users are at different locations, connection should not be established so easily. Accordingly, in a preferred embodiment, plural sets of device information may be displayed at one of the client apparatuses making a connection request to enable its user to select the device information of a desired device (client apparatus). The user may select the device information of the desired device and press a connection button to establish connection with the desired device. In another example, after the user selects the device information of the desired device and presses the connection button, a message inquiring “do you wish to allow connection with user ______?” may be displayed at the user interface (UI) of the device (client apparatus) identified by the selected device information. In turn, the user of the client apparatus with the selected device information may press an allow/deny button to establish connection with the client apparatus making the connection request.

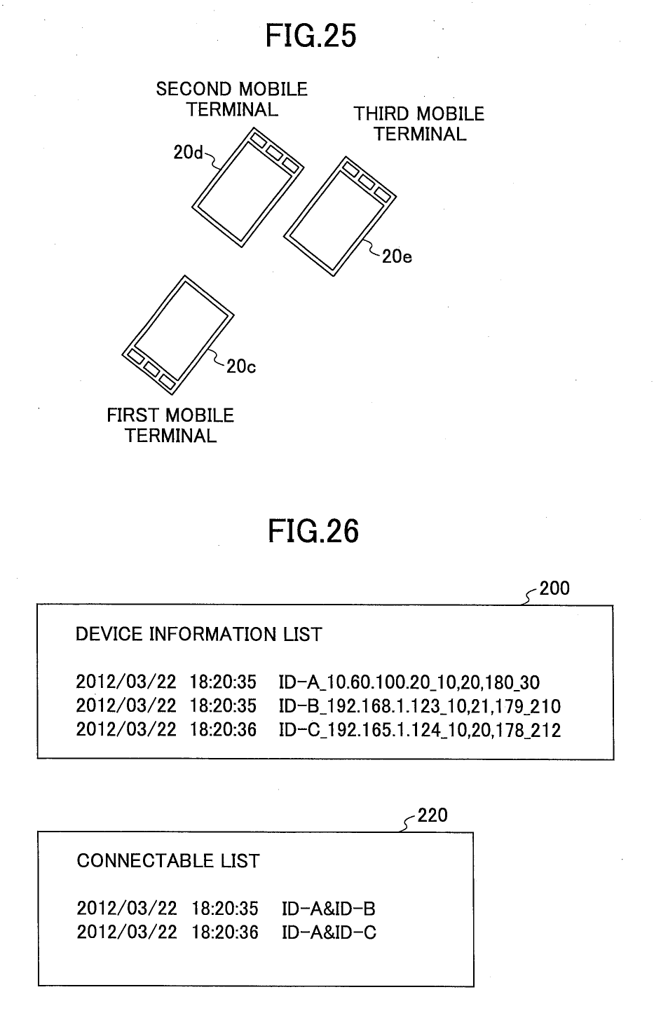

FIG. 25 illustrates a first mobile terminal 20c, a second mobile terminal 20d, and a third mobile terminal 20e as three client apparatuses to be connected according the present embodiment. In a case where the first mobile terminal 20c is vibrated at a 30-degree angle, the second mobile terminal 20d is vibrated at a 210-degree angle, and the third mobile terminal 20e is vibrated at a 212-degree angle, and assuming connection is to be allowed when devices oppose each other at 180±α degrees, connection may be established between the first mobile terminal 20c and the second mobile terminal 20d and between the first mobile terminal 20c and the third mobile terminal 20e. However, since the second mobile terminal 20d and the third mobile terminal 20e are not arranged in opposing directions, connection may not be established between these devices.

In such a case, when the second mobile terminal 20d and the third mobile terminal 20e are rearranged to face opposite each other and vibrated once more, connection may be established between these devices because the second mobile terminal 20d and the third mobile terminal 20e may then be arranged at opposing directions. However, in the present embodiment, measures are implemented to enable connection between the second mobile terminal 20d and the third mobile terminal 20e even when the second mobile terminal 20d and the third mobile terminal 20e are not rearranged to face opposite each other.

FIG. 26 illustrates an exemplary device information list 200 and an exemplary connectable list 220 that are managed in the present embodiment. For example, when connection is established between the first mobile terminal 20c and the second mobile terminal 20d, the server apparatus 10 may list up the device information of the first mobile terminal 20c and the device information of the second mobile terminal 20d. In this way, the first entry and the second entry of the device information list 200 shown in FIG. 26 may be registered.

In the present modified embodiment, the attribute part 13b of the content DB 13 includes the connectable list 220 in addition to the information illustrated in FIG. 18. Referring to the above example, when connection requests are made by the first mobile terminal 20c and the second mobile terminal 20d through the predetermined gestures, the first entry of the connectable list 220 illustrated in FIG. 26 is added. That is, information indicating that the first mobile terminal 20c and the second mobile terminal 20d may be connected and the registration date are stored in the present example.

When the third mobile terminal 20e sends a connection request to the server apparatus 10 thereafter, the server apparatus 10 adds the device information of the third mobile terminal 20e that is arranged opposite the first mobile terminal 20c in the device information list 200 as illustrated in FIG. 26.

It is noted that in the present example, the second mobile terminal 20d and the third mobile terminal 20e are arranged opposite the first mobile terminal 20c.

In such a case, the server apparatus 10 may reference the connectable list 220 and search for device information of a device that is arranged 180±α degrees opposite the first mobile terminal 20c and is therefore connectable to the first mobile terminal 20c. The server apparatus 10 may in turn find the device information of the second mobile terminal 20d and add the device information of the second mobile terminal 20d as a connectable device in its response to the third mobile terminal 20e making a connection request. In this way, the response unit 14 of the server apparatus sends a list including device information of the first mobile terminal 20c and the device information of the second mobile terminal 20d as connectable devices to the third mobile terminal 20c. In turn, the third mobile terminal 20e may determine that the first mobile terminal 20c and the second mobile terminal 20d correspond to connectable devices to which the third mobile terminal 20e may be connected.

It is noted that at this point, the second mobile terminal 20d may not be aware of the existence of the third mobile terminal 20e. However, the second mobile terminal 20d may receive a connection request from the third mobile terminal 20e after the third mobile terminal 20d receives the device information list from the server apparatus 10, and in this way, connection may be established between the second mobile terminal 20d and the third mobile terminal 20e.

According to an aspect of the present modified embodiment, even through the second mobile terminal 20d and the third mobile terminal 20e are not facing directly opposite each other, the second mobile terminal 20d and the third mobile terminal 20e may still be grouped together via the first mobile terminal 20c that is arranged opposite these two devices. In this way, the three devices may be successively connected through simple operations.

It is noted that the content DB 13 in any of the above-described embodiments may store archival information relating to a conference as conference information. For example, in a case where a user wishes to store a collaborative work produced using a shared space as archival information, the user may open a web application from his/her PC 40 after a conference and register relevant information such as conference name, start date & time, end date & time, location, attendee list, and related documents, for example.

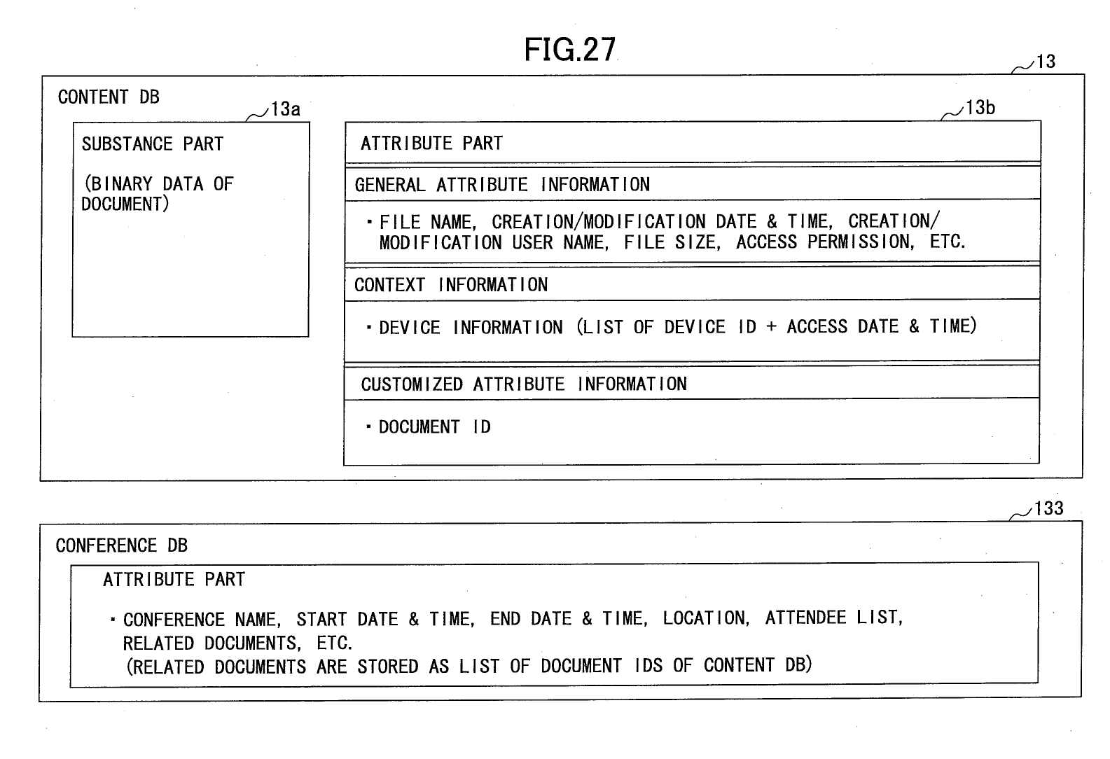

The conference information list may be stored as customized attribute information of the attribute part of the content information stored in the content DB 13 as in the above-described embodiments. In another embodiment, as illustrated in FIG. 27, a conference DB 133 that is separate from the content DB 13 may be provided, and information such as conference name, start date & time, end date & time, location, attendee list, and related documents may be managed at the conference DB 133. In this case, a document ID of a document stored in the content DB 13 may be stored as information on a related document in the conference DB 133. The conference DB 133 that stores conference information may be provided within an internal storage area of the server apparatus 10 or an external storage area such as a storage area of a cloud environment.

Also, in one embodiment, the date & time at which a connection is initially established between client apparatuses may automatically be registered as the start date & time; and the date & time at which all of the devices terminate collaboration by disconnecting from each other may automatically be registered as the end date & time. In the case where connection is established based on location, information on the corresponding location may be automatically registered as the conference location in the conference information. Also, in the case where user IDs are stored in association with device IDs, the attendee list of the conference information may be automatically generated.

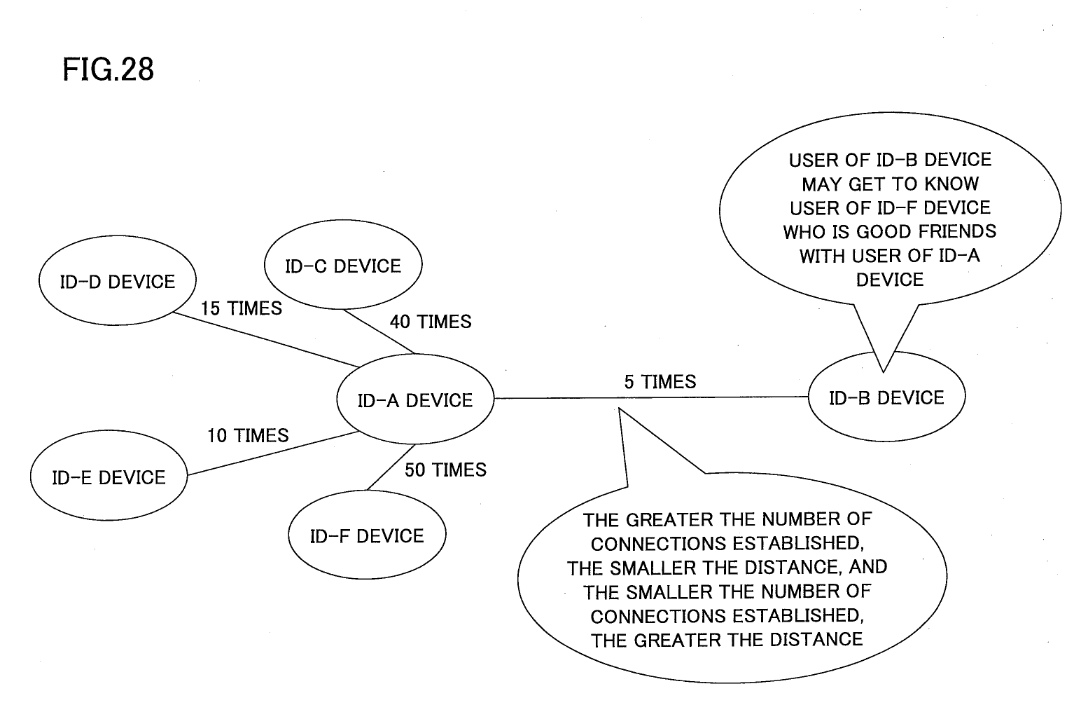

Further, in certain embodiments, the number of times predetermined gestures are made between specific client apparatuses and/or the number of times a shared space is created for use by specific client apparatuses may be counted. In this way, familiarity between specific users may be estimated based on the number of times connection requests are exchanged between their corresponding client apparatuses. For example, in FIG. 28, based on the number of connections established between different devices, the user of ID-B device may estimate that the user of ID-A device is most familiar (good friends) with the user of ID-F device. Based on such estimation, the user of the ID-B device may opt to establish contact with the user of the ID-F device over other users to build a human network, for example.

According to an aspect of the above-described embodiments of the present invention, connection may be easily established between client apparatuses through simple user operations. In this way, a person-to-person connection or a location-to-location connection may be easily established and a shared space may be easily configured to support a collaborative activity such as a conference among multiple persons, for example.

According to another aspect of the present invention, connection may be easily established between plural client apparatuses via a server apparatus such as a cloud server or a local server, for example.

According to another aspect of the present invention, connection may be easily established between plural client apparatuses based on a document to be shared in a collaborative setting (shared space) by simply having the client apparatuses read code information embedded in the document, for example. In this case, device information may be used to identify the individual client apparatuses and establish connection between the client apparatuses.

According to another aspect of the present invention, connection may be easily established between plural client apparatuses based on a location to be shared in a collaborative setting (shared space) by simple operations of the client apparatuses, for example.

According to another aspect of the present invention, connection may be easily established between plural client apparatuses based on at least one of position information or direction information of the client apparatuses. In this case, even when position information of the client apparatuses cannot be obtained, direction information of the client apparatuses may be referenced, and connection may be established between the client apparatuses by determining whether the client apparatuses are arranged in opposite directions with respect to each other, for example.

According to another aspect of the present invention, even when a client device misses the timing for establishing connection with a client apparatus, the client device may reattempt to establish connection with the client apparatus within a predetermined time period to obtain relevant information from the server apparatus so that connection may be easily and reliably established between plural client apparatuses, for example.

According to another aspect of the present invention, context information (device information) that remains stored in a database even after a predetermined time period elapses may be deleted in order to avoid establishing connection with a wrong client apparatus, for example.

According to another aspect of the present invention, plural client apparatuses may be identified as possible connection destinations and a user may select one or more client apparatuses as desired connection destinations so that connection may be simultaneously established with the selected client apparatuses, for example.

According to another aspect of the present invention, the server apparatus may be configured to send a response to a client apparatus including information relating to a connectable client apparatus with which connection may be established or an indication that there is no connectable client apparatus, and the client device may selectively allow connection with a desired client apparatus and may deny connection with an undesired client apparatus, for example.

According to another aspect of the present invention, conference information may be managed in addition to content information so that a conference may be held as a collaborative activity using a shared space. Further, by managing the conference information in a separate database from the content database, information searchablity may be improved, for example.

It is noted that although not specifically illustrated in the drawings, an electronic device such as the server apparatus or the client apparatus of the present invention may have a CPU embedded therein. The CPU may be configured to execute control programs for implementing various functional features of the electronic device. Such control programs may be stored in a storage device such as a ROM or a HDD included in a computer (not shown), for example. Alternatively the control programs may be stored in a non-volatile storage medium (memory) such as a CD-ROM, a flexible disk, a SRAM, EEPROM, or a memory card, and the control programs stored in the memory may be installed in a computer and executed by the CPU, or be read from the memory and executed by the CPU. In another example, the control programs may be stored in a storage medium or a storage area of an external device, and the control programs may be downloaded from the external device by establishing connection with the external device via a network.

While certain preferred embodiments of a communication system, a server device, and a client device according to the present invention have been described above with reference to the accompanying drawings, the present invention is not limited to these embodiments, and various modifications and changes may be made without departing from the scope and spirit of the present invention.

The present application is based on and claims the benefit of priority to Japanese Patent Application No. 2012-133233 filed on Jun. 12, 2012, with the Japanese Patent Office, the entire contents of which are hereby incorporated by reference.

What is claimed is:

1. A communication system comprising:
a client apparatus including a connection request unit that transmits a connection request that contains attribute information including client apparatus identification information identifying the client apparatus, wherein the attribute information is obtained from at least one of a desired content and a gesture made using the client apparatus; and
a server apparatus that includes
a request accepting unit that receives the connection request from the client apparatus,
a registration unit that registers the attribute information included in the received connection request, and
an association unit that determines an association of the registered attribute information and determines, based on the association of the registered attribute information, whether there is a connectable client apparatus to which the client apparatus identified by the client apparatus identification information included in the connection request can be connected.

2. The communication system as claimed in claim 1, wherein
the server apparatus includes a response unit that transmits a response including information relating to the connectable client apparatus to the client apparatus that has transmitted the connection request when the association unit determines that there is a connectable client apparatus.

3. The communication system as claimed in claim 1, wherein
the server apparatus includes a response unit that transmits a response indicating that there is no connectable client apparatus to the client apparatus that has transmitted the connection request when the association unit determines that there is no connectable client apparatus.

4. The communication system as claimed in claim 2, wherein the client apparatus that has transmitted the connection request includes
a display unit that displays the information relating to the connectable client apparatus that is received from the server apparatus; and
a device connection unit that establishes connection with a selected client apparatus that is selected based on the information relating to the connectable client apparatus displayed by the display unit.

5. The communication system as claimed in claim 4, wherein
the server apparatus is configured to create a virtual shared space and manage link information of content at the shared space, which content is designated by at least one of the client apparatuses that are connected by the device connection unit.

6. The communication system as claimed in claim 1, wherein
the attribute information obtained from the desired content includes content identification information identifying the desired content; and
the association unit determines whether there is a connectable client apparatus based on the client apparatus identification information and the content identification information.

7. The communication system as claimed in claim 6, wherein
the desired content includes a printed document including embedded information; and
the client apparatus reads the embedded information included in the printed document and extracts information on a storage area where electronic data of the printed document is stored.

8. The communication system as claimed in claim 1, wherein
the attribute information obtained from the gesture made using the client apparatus includes at least one of direction information indicating an angle in which the client apparatus is directed and position information indicating a position of the client apparatus; and
the association unit determines whether there is a connectable client apparatus based on at least one of the direction information and the position information of the client apparatus that has transmitted the connection request.

9. The communication system as claimed in claim 8, wherein
the attribute information obtained from the gesture made using the client apparatus includes access date/time information relating to the connection request; and
the association unit determines whether there is a connectable client apparatus based on at least one of the direction information and the position information of the client apparatus that has transmitted the connection request, the client apparatus identification information, and the access date/time information relating to the connection request.

10. The communication system as claimed in claim 1, wherein
when the association unit of the server apparatus determines that there is no connectable client apparatus in response to the connection request transmitted from the connection request unit of the client apparatus, the connection request unit is configured to retransmit another connection request to the server apparatus.

11. The communication system as claimed in claim 10, wherein
the connection request unit is configured to terminate the retransmission of the connection request to the server apparatus after a first predetermined time period elapses from a first time the connection request unit transmits the connection request to the server apparatus or after the connection request unit retransmits the connection request to the server apparatus a predetermined number of times.

12. The communication system as claimed in claim 1, wherein
the registration unit is configured to delete the attribute information after a second predetermined time period elapses from a time the attribute information included in the connection request is registered.

13. The communication system as claimed in claim 12, wherein
even after the second predetermined time period elapses from the time the attribute information included in the connection request is registered, the server apparatus is configured to prevent the registration unit from deleting the attribute information until a connection with the client apparatus identified by the client apparatus identification information included in the attribute information is terminated.

14. The communication system as claimed in claim 5, wherein
the attribute information included in the connection request includes conference information; and
the server apparatus is configured to manage the conference information at the shared space in conjunction with the content shared by the client apparatuses that are connected by the device connection unit.

15. The communication system as claimed in claim 14, wherein
the registration unit stores the conference information in at least one of an internal storage area of the server apparatus and an external storage area.

16. A server apparatus comprising:
a request accepting unit that receives a connection request from a client apparatus, the connection request containing attribute information including client apparatus identification information identifying the client apparatus, wherein the attribute information is obtained from at least one of a desired content and a gesture made using the client apparatus;
a registration unit that registers the attribute information included in the received connection request; and
an association unit that determines an association of the registered attribute information and determines, based on the association of the registered attribute information, whether there is a connectable client apparatus to which the client apparatus identified by the client apparatus identification information included in the connection request can be connected.

17. A client apparatus comprising:
a connection request unit that transmits to a server apparatus a connection request that contains attribute information including client apparatus identification information identifying the client apparatus, wherein the attribute information is obtained from at least one of a desired content and a gesture made using the client apparatus; and
a result receiving unit that receives from the server apparatus a result of determining an association of registered attribute information including the attribute information contained in the transmitted connection request and determining, based on the association of the registered attribute information, whether there is a connectable client apparatus to which the client apparatus identified by the client apparatus identification information included in the connection request can be connected.
